(19) United States
(12) Patent Application Publication
(10) Pub. No.: US 2026/0071475 A1
(43) Pub. Date: Mar. 12, 2026

(54) HOME APPLIANCE

(71) Applicant: LG Electronics Inc., Seoul (KR)

(72) Inventors: Minho LEE, Seoul (KR); Sanggyun LEE, Seoul (KR); Jaeun SHIN, Seoul (KR)

(21) Appl. No.: 19/320,797

(22) Filed: Sep. 5, 2025

(30) Foreign Application Priority Data
Sep. 6, 2024 (KR) 10-2024-0121766
Aug. 27, 2025 (KR) 10-2025-0119783

(51) Int. Cl. E05F 5/06

(52) U.S. Cl. CPC E05F 5/06; E05Y 2900/30

(57) ABSTRACT

A home appliance includes a cabinet providing a storage compartment that opens forward, a door rotatably provided at the front of the cabinet to open and close the storage compartment, a hinge fixed to the cabinet and rotatably supporting the door, the hinge including a first hinge shaft disposed vertically, a guide member provided in the door and including a shaft insertion groove into which the first hinge shaft is inserted, the shaft insertion groove extending in an arc shape with a width corresponding to a diameter of the first hinge shaft, a first deceleration part provided in the guide member and including a first protrusion protruding into the shaft insertion groove, wherein the first protrusion is movable in the width direction of the shaft insertion groove.

### CROSS-REFERENCE TO RELATED APPLICATIONS

This application claims the benefit of Korean Patent Application No. 10-2024-0121766, filed on Sep. 6, 2024, and Korean Patent Application No. 10-2025-0119783, filed on Aug. 27, 2025. The disclosures of the prior applications are incorporated by reference in their entirety.

### BACKGROUND

### 1. Field

The present disclosure relates to home appliances such as refrigerators, and more specifically, to home appliances with doors.

### 2. Description of the Related Art

Home appliances have an internal storage or processing chamber and can supply cold air, heat, steam, or water to the storage or chamber to control or maintain the conditions of items contained therein. Examples of such home appliances include refrigerators for keeping food or beverages fresh, and clothing treatment apparatuses (e.g., Stylers) for deodorizing, drying, or refreshing clothing.

A door is positioned at the front of the storage compartment or processing chamber. Recently, home appliances are increasingly being used alongside furniture or other appliances. In this context, home appliances with doors that are thinner than conventional doors are being released to match the depth in the front-to-back direction with that of the furniture or other appliances.

If a door closes quickly, impact may occur between the door and a cabinet.

Korean Patent Publication No. 10-2018-0119985 (hereinafter, “Prior Document 1”) discloses a refrigerator including a damper mounted on the cabinet and protruding forward. The damper in Prior Document 1 has a portion exposed to the outside when the door is opened.

Meanwhile, if the door of a home appliance such as a refrigerator is not completely closed, cold air from the storage compartment may escape, and to solve this problem, an ‘auto-closing’ function has been required to induce the door to automatically close when the door is opened at a certain angle or less.

If a device providing such an auto-closing function is attached to a hinge shaft and directly applies torque to the hinge shaft, a large force may be required to rotate the door. Consequently, the device may be bulky to provide such a large force. Patent Publication No. 10-2024-0057859 (hereinafter, “Prior Document 2”) discloses an auto-closing device that interacts with a hinge bracket body. The auto-closing device of Prior Document 2 has a potential problem in that, depending on the shape of the hinge bracket body, the force provided by the auto-closing device to the door may act in the direction of door opening.

### SUMMARY

An object of the present disclosure is to solve the aforementioned problems and other problems.

Another object is to provide a home appliance for reducing the impact between the cabinet and the door when the door is closed, thereby ensuring smooth closing.

Another object is to provide a home appliance with a damping function implemented in a manner that does not compromise the appearance or insulation performance.

Another object is to provide a home appliance including a deceleration part applicable to doors of various structures.

For example, an object may be to provide a home appliance including a deceleration part applicable to a door whose rotation center varies depending on the door opening angle, or a door that is thinner than conventional doors.

Another object may be to provide a home appliance equipped with an auto-closing device that provides a closing force to a door when the opening angle of the door is below a certain angle.

Another object is to provide a home appliance including both an auto-closing device and a deceleration part.

The objects of the present disclosure are not limited to the objects mentioned above, and other objects not mentioned will be clearly understood by those skilled in the art from the description below.

According to one aspect of the present disclosure for achieving the above-described objects, a home appliance including a deceleration part that reduces a closing speed of a door when the door is closed is provided.

In accordance with an aspect of the present disclosure, a home appliance includes a cabinet providing a storage compartment that opens forward, a door rotatably provided at the front of the cabinet to open and close the storage compartment, a hinge fixed to the cabinet and rotatably supporting the door, the hinge including a first hinge shaft, a guide member provided in the door and including a shaft insertion groove into which the first hinge shaft is inserted, and a first deceleration part provided in the guide member and including a first protrusion protruding into the shaft insertion groove. Wherein the shaft insertion groove has a width corresponding to a diameter of the first hinge shaft and extends such that the first hinge shaft is slidable along the shaft insertion groove based on rotation of the door with respect to the cabinet, and the first protrusion is movably disposed in the width direction of the shaft insertion groove.

The shaft insertion groove may extend in an arc shape.

The first hinge shaft may be disposed vertically.

The first hinge shaft may be positioned between one end of the shaft insertion groove and the first protrusion when the door is closed.

The home appliance may include a second deceleration part provided in the guide member, spaced apart from the first deceleration part, and including a second protrusion protruding into the shaft insertion groove.

The shaft insertion groove may include a first curved part extending rearward toward the outer end of the door in the width direction of the door, and a second curved part extending from the first curved part toward the outer end of the door and extending forward toward the outer end of the door.

The first deceleration part may be positioned in the first curved part, and the second deceleration part may be positioned in the second curved part.

The hinge may further include a second hinge shaft spaced apart from the first hinge shaft. The second hinge shaft may be disposed vertically. The second hinge shaft may have the same diameter as the first hinge shaft.

The second hinge shaft may be positioned between the other end of the shaft insertion groove and the second protrusion when the door is open.

The first protrusion may include a first inclined surface positioned opposite the one end, and a second inclined surface located on the one end.

The first inclined surface may be more gently inclined than the second inclined surface.

The guide member may further include a deceleration housing provided on the outer surface of the guide member and accommodating the first deceleration part, and a through hole penetrating the outer surface of the guide member and connecting an internal space of the deceleration housing with the shaft insertion groove, the first protrusion being inserted into the through hole.

The first deceleration part may further include an elastic portion disposed in the deceleration housing and pressing the first protrusion toward the shaft insertion groove.

Specific details of other embodiments are included in the detailed description and drawings.

According to at least one embodiment of the present disclosure, it is possible to provide a home appliance that reduces the impact between a cabinet and a door when the door is closed, thereby ensuring smooth closing. For example, the home appliance can include a deceleration part to reduce the door closing speed.

According to at least one embodiment of the present disclosure, it is possible to provide a home appliance including a deceleration part provided in a guide member that accommodates a hinge shaft and implemented in a manner that does not compromise the appearance or insulation performance.

According to at least one embodiment of the present disclosure, it is possible to provide a home appliance including a deceleration part provided in a guide member that accommodates a hinge shaft such that a deceleration function is provided to a door whose rotation center varies depending on the door opening angle or a door that is thinner than conventional doors.

According to at least one embodiment of the present disclosure, it is possible to provide a home appliance equipped with an auto-closing device that provides a closing force to a door when the opening angle of the door is below a certain angle.

According to at least one of the embodiments of the present disclosure, it is possible to provide a home appliance including both an auto-closing device and a deceleration part.

### BRIEF DESCRIPTION OF THE DRAWINGS

FIG. 1 is a front view of a refrigerator according to an embodiment of the present disclosure.

FIG. 2 is a perspective view of a clothing treatment apparatus according to another embodiment of the present disclosure.

FIG. 3 is a perspective view and an enlarged view of a door illustrated in FIG. 1.

FIG. 4 is an exploded perspective view of the configuration illustrated in FIG. 3, and is an exploded perspective view of a door, a hinge, a guide member, and an auto-closing device of a home appliance according to an embodiment of the present disclosure.

FIGS. 5A to 5C are enlarged views of the part illustrated in FIG. 1, wherein (A) is the interior of the door, (B) is a front view with the cover removed, and (C) is a front view.

FIG. 6 and FIG. 7 are exploded perspective views of the auto-closing device illustrated in FIG. 4.

FIG. 8 is a bottom view of a door illustrating an auto-closing system of a home appliance according to an embodiment of the present disclosure.

FIGS. 9A to 9D are diagrams illustrating the positions of a lever and a reference pin according to the opening angle of the door illustrated in FIG. 8.

FIG. 10 is a graph showing the torque of a driver, clutch engagement and disengagement, and lever engagement according to the door opening angle of the home appliance according to an embodiment of the present disclosure.

FIG. 11 is a diagram illustrating an auto-closing device of a home appliance according to third and fourth embodiments of the present disclosure.

FIG. 12 is a bottom view of a door illustrating an auto-closing device for a home appliance according to a fifth embodiment of the present disclosure.

FIG. 13 is an exploded perspective view of the guide member and deceleration part illustrated in FIG. 4.

FIGS. 14A and 14B and FIGS. 15A and 15B are diagrams illustrating the operation of the lever and the deceleration part depending on the opening angle of the door of the home appliance according to an embodiment of the present disclosure.

### DETAILED DESCRIPTION

Hereinafter, embodiments disclosed in this specification will be described in detail with reference to the attached drawings. Regardless of the reference numerals used in the drawings, identical or similar components will be assigned the same reference numerals, and redundant descriptions thereof will be omitted.

When a component is referred to as being “coupled” or “connected” to another component, it should be understood that the component may be directly coupled or connected to the other component, but that other components may also be present in between. Conversely, when a component is referred to as being “directly coupled” or “directly connected” to another component, it should be understood that there are no other components present in between.

The singular expression includes plural expression unless the context clearly indicates otherwise.

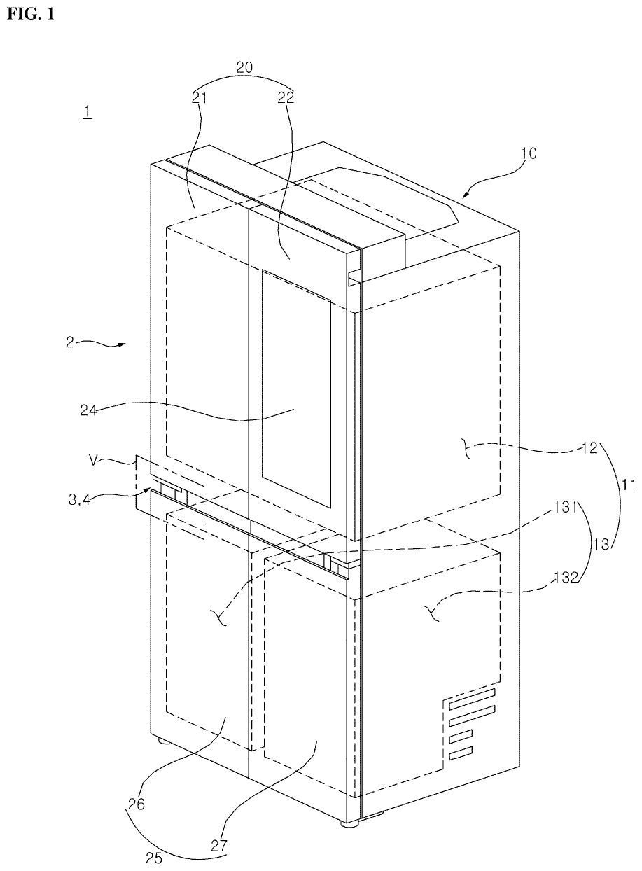

Referring to FIG. 1, a home appliance according to an embodiment of the present disclosure may be a refrigerator. The refrigerator 1 includes a cabinet 10 providing a storage compartment 11 and a door 2 for opening and closing the storage compartment 11.

The storage compartment 11 may be openable toward the front. The storage compartment 11 may provide a space and/or configuration for storing food or beverages inside. The storage compartment 11 may be configured to open toward the front, facilitating user access and food storage.

A plurality of storage compartments 11 may be provided. For example, the storage compartment 11 may include an upper storage compartment 12 and a lower storage compartment 13 partitioned vertically. The upper storage compartment 12 may be provided as a refrigerator compartment, and the lower storage compartment 13 may be provided as a freezer compartment. However, the configuration of the refrigerator and freezer compartments is not limited thereto.

The door 2 is provided at the front of the cabinet 10 and can open and close the storage compartment 11. The door 2 is rotatably provided at the front of the cabinet 10 and can open and close the storage compartment 11.

The door 2 may include an upper door 20 that opens and closes the upper storage compartment 12. The door 2 may include a lower door 25 that opens and closes the lower storage compartment 13.

A plurality of doors 2 may be provided. A plurality of doors 2 may open and close a single storage compartment. For example, the single upper storage compartment 12 may be opened and closed by a first door 21 and a second door 22. That is, the first door 21 can open and close a part of the upper storage compartment 12 (the left side in FIG. 1), and the second door 22 can open and close another part of the upper storage compartment 12 (the right side in FIG. 1).

A plurality of doors 20 may be provided, and a single storage compartment may be opened and closed by a single door. For example, the lower storage compartment 13 may be divided into two storage compartments 131 and 132 by left and right partitions, and the lower door 25 for opening and closing the lower storage compartment 13 may include a first lower door 26 for opening and closing a first lower storage compartment 131 and a second lower door 27 for opening and closing a second lower storage compartment 132.

The aforementioned multiple storage compartments 11 and doors 2 may be configured differently. For example, the upper storage compartment 12 may be partitioned into left and right sections, or the lower storage compartment 13 may be provided as a single unit without being partitioned into left and right sections.

Food may be stored in the storage compartment 11. Cool air may be supplied to the storage compartment 11. The door 2 may close the storage compartment 11 to prevent the cool air from leaking to the outside.

The refrigerator 1 may include a refrigeration cycle. The refrigeration cycle may exchange heat with air to supply cool air to the storage compartment.

Shelves and/or drawers may be disposed inside the storage compartment 11. The door 2 may also include shelves to store food.

A storage space may also be formed inside the door 2, increasing storage capacity.

The door 2 may further include a window 24. The window 24 may be formed of a transparent or translucent material, allowing the interior of the storage compartment to be visually inspected from the outside.

The window 24 may enable the food inside to be identified from the outside when the door or the interior of the storage compartment is illuminated.

The window 24 may have a display function. Therefore, the window 24 may also be referred to as a display 24. The window 24 may display the state of the refrigerator 1 and the state of the inside of the storage compartment 11.

The window 24 may serve as a user interface means and receive commands from a user. For example, the window 24 may include a touch display that operates by detecting touch input of a user.

The refrigerator 1 may include a hinge 3 that connects the cabinet 10 and the door 2. The hinge 3 may rotatably support the door 2 relative to the cabinet 10. The door 2 may be rotatably coupled to the cabinet 10 by the hinge 3.

The hinge 3 may connect the upper and lower portions of the door 2 to the cabinet 10. For example, the hinge 3 may be provided at each of the upper and lower portions of the upper door 20, and the hinge 3 may also be provided at each of the upper and lower portions of the lower door 25.

The refrigerator 1 may include an auto-closing device 4 that provides a closing force to the door 2. The auto-closing device 4 may be provided at the upper or lower portion of the door 2, or at each of the upper and lower portions. A detailed description of the auto-closing device 4 will be described later.

The left-right direction (the direction in which the first and second doors 21 and 22 are arranged) of FIG. 1 may be referred to as the width direction of the refrigerator, the width direction of the cabinet 10, or the width direction of the door 2.

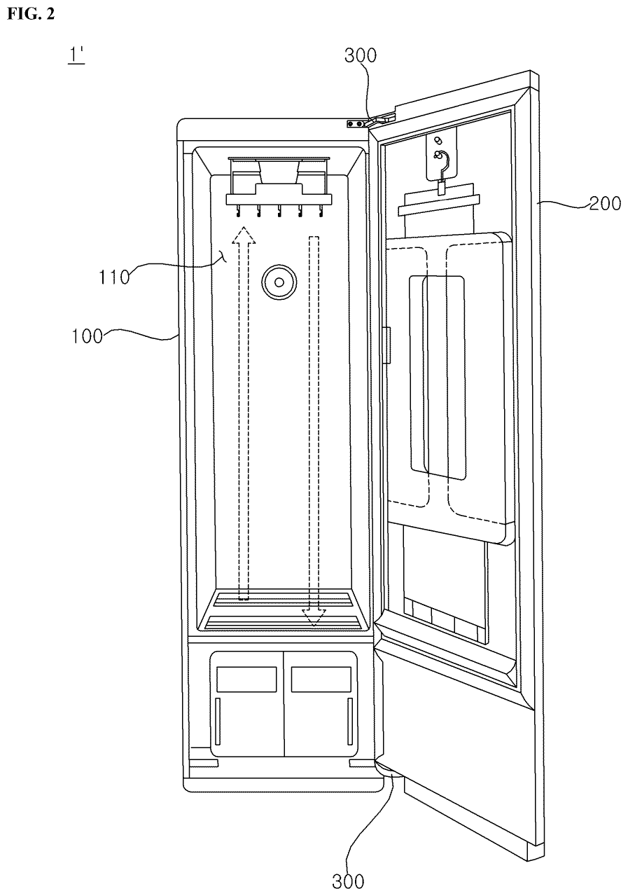

Referring to FIG. 2, a home appliance according to an embodiment of the present disclosure may be a clothing treatment apparatus 1′. The clothing treatment apparatus 1′ includes a cabinet 100 providing a treatment chamber 110, a door 200 for opening and closing the treatment chamber 110, and a hinge 300 for rotatably connecting the door 200 to the cabinet 100. The hinge 300 may disposed at an upper part and/or a lower part of the door 200.

The treatment chamber 110 may be opened forward. The treatment chamber 110 may provide an internal space for storing or treating clothing. The treatment chamber 110 may be configured to be open forward to facilitate user access.

The clothing treatment apparatus 1′ can supply air with controlled temperature and humidity into the treatment chamber 110 and take the air back. In addition, the clothing treatment apparatus 1′ can supply steam into the treatment chamber 110. Clothing, etc., can be hung inside the treatment chamber 110.

Hereinafter, the present disclosure will be described using the refrigerator 1 as an example, but the present disclosure can also be applied to the clothing treatment apparatus 1′. For example, the components mounted in the door 2 and cabinet 10 of the refrigerator 1 can be mounted in the door 200 and cabinet 100 of the clothing treatment apparatus 1′. For example, the hinge 300 of the clothing treatment apparatus 1′ may have the same structure as the hinge 3 of the refrigerator 1, and the auto-closing device 4 may be mounted on the door 200 of the clothing treatment apparatus 1′. Additionally, a soft closing device 7 may be mounted on the door 200 of the clothing treatment apparatus 1′.

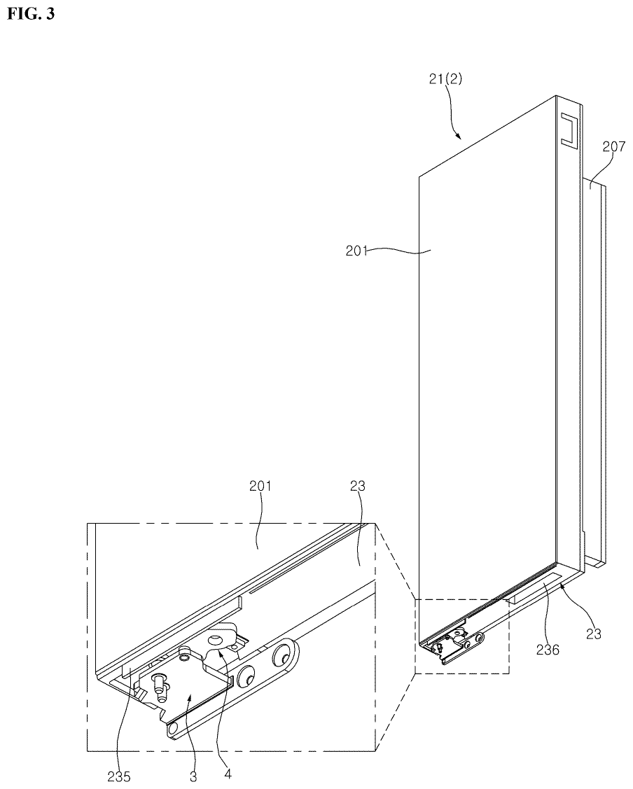

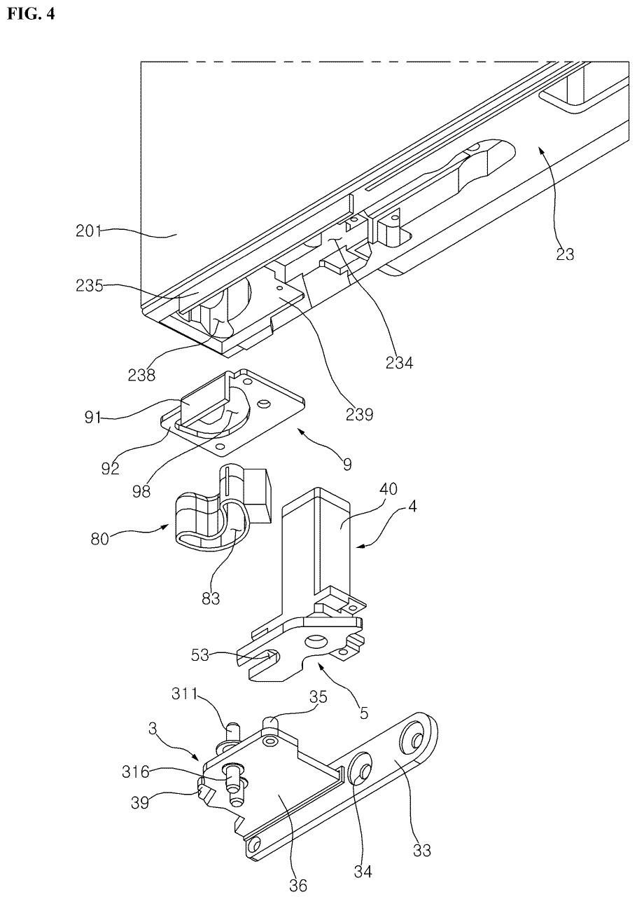

Hereinafter, the door 2 will be described with reference to FIGS. 3 and 4. The first door 21 will be described as an example, but the features described below can also be applied to the second door 22 or the lower door 25.

Referring to FIGS. 3 and 4, the door 2 may include a door panel 201 forming the exterior. The door panel 201 may provide the front surface of the door 2. Hereinafter, the door panel 201 may also be referred to as the front surface of the door or the front surface of the refrigerator.

The door 2 may include a front surface 201 and a rear surface 202. The front surface 201 constitutes the outer surface of the door, and the rear surface 202 constitutes the inner surface facing the storage compartment 11.

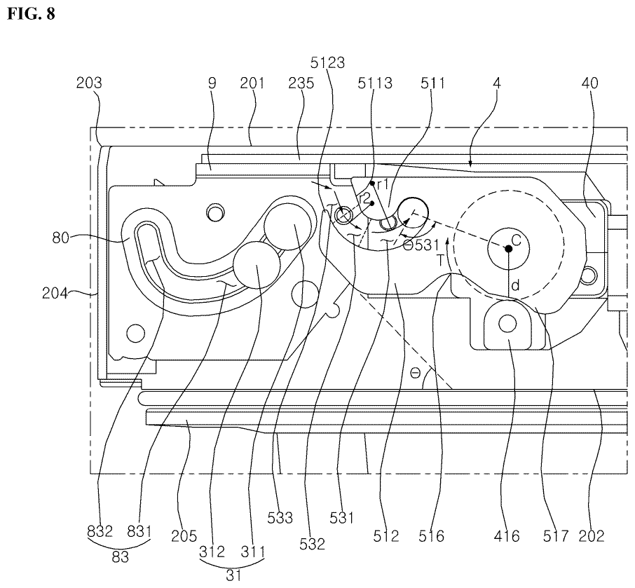

A gasket (205, refer to FIG. 8) may be provided on the rear surface 202 of the door 2 to seal the storage compartment 11 when the door 2 is closed.

A filler 207 may be provided on one side of the door 2. The filler 207 may be provided on the rear surface of the door 2.

The filler 207 is configured to close the gap between the first door 21 and the second door 22, thereby improving insulation and appearance quality when both doors are closed.

The filler 207 may be rotatably installed and may be linked to the opening and closing operations of the door.

The door 2 may include a lower cap deco 23 that provides the lower surface of the door 2. The lower cap deco 23 may be attached to the lower end of the front surface 201 and the lower end of the rear surface 202 of the door 2.

The door 2 may include an upper cap deco that provides the upper surface of the door 2. The upper cap deco may be attached to the upper end of the front surface 201 and the upper end of the rear surface 202 of the door 92.

Accordingly, the door 2 may have an internal space, and the internal space of the door 2 may be filled with an insulation material. This allows the storage compartment 11 to be insulated from the outside when the door 2 closes the storage compartment 11.

Hereinafter, the lower cap deco 23 will be referred to as a cap deco 23, and the description of the cap deco 23 can be applied directly or similarly to the upper cap deco.

A handle 236 may be provided on the lower surface of the door 2. The handle 236 may be recessed upward from the lower surface of the door 2. The handle 236 may be located on the opposite side of the hinge 3 in the width direction of the door 2.

The handle 236 may be provided in the cap deco 23.

The hinge 3 provided on the lower surface of the door 2 may be coupled to the lower surface of the door 2, and the hinge provided on the upper surface of the door 2 may be coupled to a mounting part provided on the upper surface or upper portion of the door 2. Hereinafter, the hinge 3 and a guide member 80 provided at the bottom of the door 2 will be described as an example, and the descriptions can also be applied to the hinge 3 and the guide member 80 provided at a different location.

The hinge 2 is secured to the cabinet 10 and can support the door 2. The hinge 3 may include a hinge shaft 31 that rotatably supports the door 2. The hinge 3 may include a coupling portion 33 fixed to the cabinet 10.

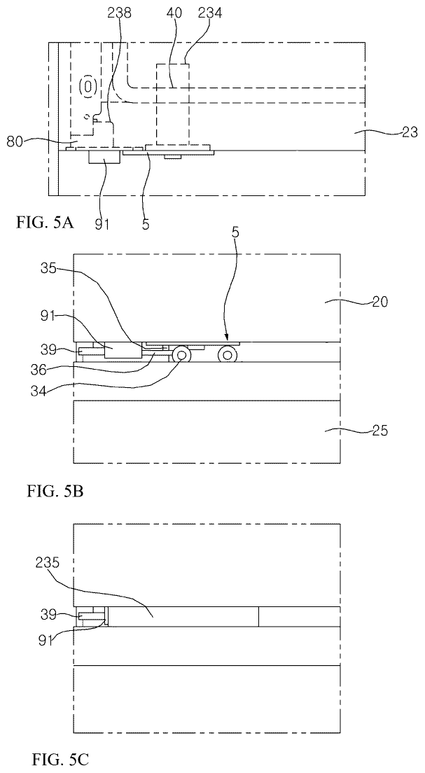

A fastening hole 34 is formed in the coupling portion 33, allowing the hinge to be secured to the cabinet via a fastening member. The fastening hole 34 may be positioned at a position spaced apart from a reference pin 35 which will be described below in the width direction of the cabinet 10 (refer to FIG. 5B). Accordingly, the hinge can be secured to the cabinet via the fastening member without structural interference.

The hinge 3 may include a supporter 36 that protrudes forward from the cabinet 10. The supporter 36 may protrude forward from the coupling portion 33. The supporter 36 may be disposed horizontally.

The hinge shaft 31 may protrude from the supporter 36. The hinge shaft 31 may protrude vertically from the supporter 36.

The hinge provided on the lower side of the upper door 20 and the hinge provided on the upper side of the lower door 25 may have hinge shafts 311 and 316 protruding upward and downward from the single supporter 36. That is, the hinge shaft 311 protruding upward from the supporter 36 may support the lower side of the upper door 20, and the hinge shaft 316 protruding downward from the supporter 36 may support the upper side of the lower door 25.

The door 2 may include the guide member 80 coupled to the hinge 3. The guide member 8 may be inserted into the lower surface or upper surface of the door 2.

The guide member 80 may include a shaft insertion groove 83 into which the hinge shaft 31 is inserted. The door 2 can be opened and closed by the hinge shaft 31 rotating in the shaft insertion groove 83 or moving along the shaft insertion groove 83.

When the door 2 is opened and closed as the hinge shaft 31 moves along the shaft insertion groove 83, the position of the rotation center of the door 2 can change depending on the degree of opening of the door 2. This provides the advantage of preventing the door from interfering with other furniture or storage units placed next to the refrigerator when opened.

However, the structure of the hinge 3 and guide member 80 makes it difficult to close the door by directly applying torque to the hinge shaft. The auto-closing device 4 of the present disclosure can also be applied to the door 2 that opens and closes as the hinge shaft 31 moves along the shaft insertion groove 83.

A deceleration part 87 may be provided in the guide member 80, and detailed description of the structure of the guide member 80, movement of the hinge shaft 31, and the deceleration part 87 will be described later.

According to an embodiment of the present disclosure, the door 2 may be automatically closed even when a user does not completely close the door 2. Such a function may be implemented through interaction between the auto-closing device 4 provided at the door 2 and the reference pin 35 provided at the cabinet 10. The auto-closing device 4 and the reference pin 35 together may be referred to as an auto-closing system. The auto-closing system may also be understood as a concept further including the hinge 3 that connects the door 2 and the cabinet 10.

The auto-closing system may provide a force in a closing direction of the door 2 by interaction between the auto-closing device 4 and the reference pin 35 when the door 2 is opened within a predetermined angle. For example, when the door 2 is opened/closed within a certain angle, the reference pin 35 may be positioned in a slit 53 of a lever 5 described below, and a driving unit 40 may rotate the lever 5. Accordingly, even if the user does not completely close the door 2, the door 2 may be automatically closed. Hereinafter, the auto-closing system will be described.

The auto-closing device 4 may be provided on the lower surface of the door 2. The auto-closing device 4 may provide a force to close the door 2. When the angle between the cabinet 10 and the door 2 is equal to or less than a predetermined angle while the door 2 is open, the auto-closing device 4 may provide a force to close the door.

The auto-closing device 4 may include a driver 40 and a lever 5 coupled to the driver 40. The lever 5 may be rotatably coupled to the driver 40. The driver 40 may provide torque to the lever 5. The lever 5 may rotate in accordance with the opening and closing operation of the door 2.

The driver 40 may be spaced apart from the hinge shaft 31 in the rotational radius direction of the door 2. The auto-closing device 4 may close the door 2 by applying force to the hinge 3 via the lever 5. The lever 5 may apply force to a component of the hinge 3 other than the hinge shaft 31.

The hinge 3 may include a reference pin 35 to which the lever 5 applies force. The reference pin 35 may be spaced apart from the hinge shaft 31. The reference pin 35 may be provided on the supporter 36. The position of the reference pin 35 with respect to the cabinet 10 may be fixed. The reference pin 35 may protrude vertically from the supporter 36. The reference pin 35 may extend parallel to the hinge shaft 31.

Meanwhile, although the reference pin 35 has been described as a subordinate component of the hinge 3, the reference pin 35 may be configured as a component separate from the hinge 3. For example, instead of protruding from the support 36 of the hinge 3, the reference pin 35 may be formed as a separate component independent of the hinge 3, and the hinge 3 and the reference pin 35 may be respectively fixed to the cabinet 10.

The lever 5 may include a slit 53 into which the reference pin 35 is inserted. The reference pin 35 may slide in or out of the slit 53 according to the opening and closing operation of the door 2. Depending on the opening angle of the door 2, the reference pin 35 may slide in the slit 53 of the lever 5, and the lever 5 may rotate. Alternatively, the position of the reference pin within the slit 53 and the opening angle of the door 2 may be determined depending on the rotation angle of the lever 5. Sliding of the reference pin 35 in the slit 53 may mean that, since the reference pin 35 is fixed, the relative position of the reference pin 35 with respect to the slit 53 changes according to rotation and movement of the lever 5.

The door 2 may include a stopper 9. The stopper 9 may prevent the door 2 from opening beyond a set angle. For example, the set angle may be set within a range of 100 to 180 degrees.

The stopper 9 may include a stopper body 91 that protrudes downward from the lower surface of the door 2.

The hinge 3 may include a stopper contact portion 39. The stopper contact portion 39 may be provided on the supporter 36. The stopper contact portion 39 may be formed on the front portion of the supporter 36 and the outer portion in the width direction of the cabinet.

During the opening process of the door 2, the stopper body 91 may contact the stopper body contact portion 39. Accordingly, the maximum opening angle of the door 2 may be limited. The maximum opening angle of the door 2 may refer to the aforementioned set angle.

The stopper 9 may include a stopper bracket 92. The stopper bracket 92 may be mounted on the lower surface of the door 2.

A hole 98 may be formed in the stopper bracket 92. The hole 98 can penetrate the stopper bracket 92 vertically. The guide member 80 can be inserted into the hole 98. The guide member 80 can pass through the stopper bracket 92 vertically.

The stopper body 91 may be positioned behind a cover 235, which will be described later. A portion of the stopper body 91 may overlap the cover 235 in the front-to-back direction, and the remaining portion may protrude outwardly in the width direction of the door 2 from the cover 235.

The cover 235 may be provided in front of the lever 5. The cover 235 may protrude downward from the lower surface of the door 2. The cover 235 may be positioned behind the front surface 201 of the door. The cover 235 serves as an exterior component that conceals mechanical parts exposed at the lower end of the lever 5 or the door 2, thereby providing both aesthetic appeal and safety.

Referring to FIGS. 4 and 5, the cap deco 23 may include a guide housing 238. The guide housing 238 may accommodate the guide member 80. The guide member 80 may be mounted and secured to the guide housing 238.

The guide housing 238 may be recessed upward from the lower surface of the door 2. The guide housing 238 may have a shape corresponding to the guide member 80.

The guide housing 238 may be provided in a stopper mounting portion 239. The guide housing 238 may be recessed upward from the stopper mounting portion 239.

The cap deco 23 may include an auto-closing receiving portion 234 in which the auto-closing device 4 is disposed. The auto-closing receiving portion 234 may be recessed upward from the lower surface of the door 2 to provide a space for accommodating the auto-closing device 4. The cap deco 23 may include a soft-closing receiving portion 237 in which the soft closing device 7 is mounted. The soft-closing receiving portion 237 may be recessed upward from the lower surface of the door 2.

At least a portion of each of the guide member 80, the stopper 9, and the auto-closing device 4 can be covered from the front outside through the guide housing 238, the stopper mounting portion 239, the auto-closing receiving portion 234, and the soft-closing receiving portion 237 of the cap deco 23. For example, the driver 40 can be covered from the front outside by the cap deco 23, and the lever 5 is positioned lower than the lower surface of the door 2 and thus may not be hidden by the cap deco 23. For example, the upper portion of the soft closing device 7 can be covered from the front outside by the cap deco 23, and the lower portion thereof protrudes downward from the lower surface of the door 2 and thus may not be hidden by the cap deco 23. For example, at least a portion of the stopper body 91 may protrude downward from the lower surface of the door 2 and thus may not be covered from the front outside by the cap deco 23.

The cover 235 may be positioned in front of the lever 5 to cover the lever 5 from the front outside.

Furthermore, a portion of the stopper body 91 may be positioned behind the cover 235 to be covered from the front outside. The outer end of the stopper body 91 is positioned outside the cover 235 in the width direction of the cabinet 10 and thus the stopper body 91 may be exposed to the front. This allows a portion of the stopper body 91 to be covered by the cover body 235, and when the door 2 is opened at the maximum angle, the outer end of the stopper body 91 can contact the stopper contact portion 39.

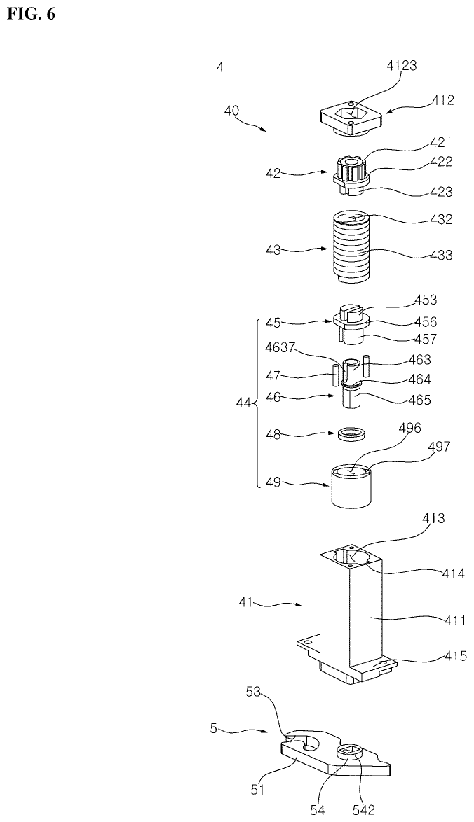

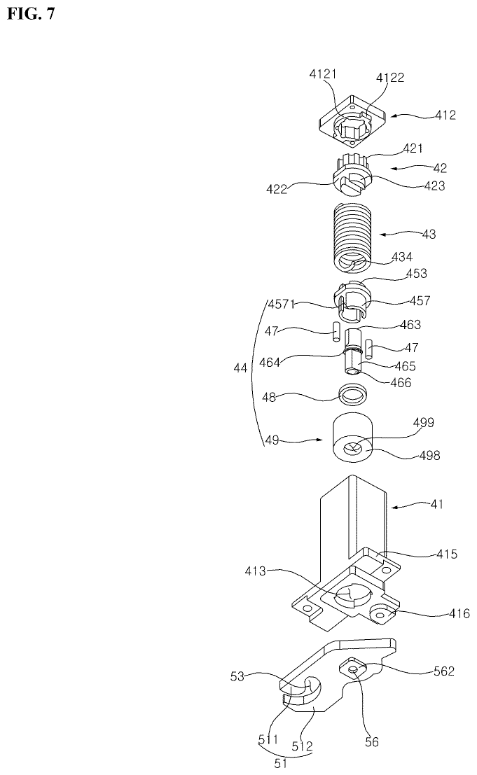

Referring to FIGS. 6 and 7, the driver 40 may include a housing 41. The housing 41 may be secured to the cabinet 10 and may provide an internal space 413 for accommodating a plurality of components therein.

The upper portion of the housing 41 may be open, and a housing cover 412 may be coupled to the upper end of the housing 41. The housing cover 412 may cover the housing 41. The housing cover 412 may include a first protrusion 4121 protruding downward. The first protrusion 4121 may be inserted into the internal space 413 of the housing 41, thereby coupling the housing cover 412 to the housing 41.

The housing 41 may include a coupling groove 414 extending outward from the space 413. The housing cover 412 may include a second protrusion 4122 inserted into the coupling groove 414.

The second protrusion 4122 may protrude outward from the outer periphery of the first protrusion 4121. The cover 412 may be secured to the housing 41 by being inserted into the coupling groove 414 of the housing 41. The cover 412 may be restrained to the housing 41 so as not to rotate.

A spring 43, a clutch 44, a lever shaft 46, etc. may be inserted into the internal space 413 of the housing 41. These elements may be inserted from the upper side of the housing 41 before the housing cover 412 is coupled to the housing 41.

The driver 40 may include the spring 43. The spring 43 may be a torsion spring that provides torque. The spring 43 may be mounted to provide torque in the direction in which the door 2 closes.

The driver 40 may include a holder 42 to which the spring 43 is coupled. One end 432 of the spring 43 may be coupled and/or fixed to the holder 42.

The holder 42 may be coupled and/or fixed to the housing cover 412. The holder 42 may include a fixing portion 421 extending upward. The fixing portion 421 may be inserted into an insertion hole 4123 formed in the cover 412.

The holder 42 may include a support portion 422. The support portion 422 may have a width greater than that of the fixing portion 421. The support portion 422 may be in contact with the lower surface of the housing cover 412.

The holder 42 may include a first spring coupling portion 423. One end 432 of the spring may be coupled to the first spring coupling portion 423. The first spring coupling portion 423 may protrude downward from the lower surface of the support portion 422. The support portion 422 may support the upper end of the spring 43.

The driver 4 may provide rotational force to the lever 5 through the operations of the spring 43, the clutch 44, and the shaft 46.

The spring 43 may include one end 432 and the other end 434. A spiral portion 433 extending spirally may be formed between the one end 432 and the other end 434. The spring 43 is configured as a torsion spring and may generate rotational torque in a certain direction.

The shaft 46 is connected to the spring 43 and can receive torque. The shaft 46 is coupled to the lever 5 and can rotate integrally with the lever 5.

The clutch 44 is positioned between the spring 43 and the shaft 46, selectively controlling connection of the spring 43 and the shaft 46. That is, the clutch 44 can selectively connect or disconnect the spring 43 and the shaft 46. The clutch 44 may connect or disconnect the spring 43 and the shaft 46 based on the rotation angle of the lever 5.

For example, when the door 2 is closed, the clutch 44 connects the spring 43 and the shaft 46 while the lever 5 rotates to a preset angle, and when the lever 5 rotates further, the clutch 44 can disconnect the spring 43 and the shaft 46. The preset angle is referred to as a switching angle. The “connection” is also called “coupling.”

When the lever 5 or the shaft 46 rotates due to an external force, the elastic energy stored in the spring 43 can increase. When the spring 43 is rotated from a free state and no external force is applied to the lever 5 and the shaft 46, or when the elastic force of the spring 43 is greater than the external force applied to the lever 5 and the shaft 46, the lever 6 and the shaft 46 can be rotated by the elastic force of the spring 43. When the clutch 44 releases connection between the spring 43 and the shaft 46, the spring 43 may not rotate even if the lever 5 and the shaft 46 rotate.

The clutch 44 can restrict or release the rotation of the shaft 46. The clutch 44 can restrict or release the rotation of the shaft 46 based on the rotation angle of the lever 5. For example, when the rotation angle of the lever 5 is equal to or greater than a locking angle that is greater than the switching angle, the clutch 44 can restrict the rotation of the shaft 46, and when the rotation angle of the lever 5 is less than the locking angle, the clutch 44 can release the restriction of the shaft 46.

That is, when the door 2 is opened from a closed state and the lever 5 rotates by the operation of the reference pin 35, the clutch 44 can release the connection between the spring 43 and the shaft 46 when the rotation angle of the lever 5 is greater than the switching angle and can restrict the rotation of the shaft 46 when the lever 5 rotates further and the rotation angle of the lever 5 becomes the locking angle. Therefore, even if the door 2 is opened further, the position of the lever 5 can be fixed.

In addition, when the door 2 is closed, the reference pin 35 enters the slit 53, and the lever 5 rotates by the operations of the reference pin 35 and the lever 5, releasing the restriction. When the lever 5 rotates further and the rotation angle of the lever 5 becomes smaller than the switching angle, the clutch 44 connects the spring 43 and the shaft 46, and thus the lever 5 rotates by the torque of the spring 43, and the door 2 can be automatically closed by the operations of the lever 5 and the reference pin 35 even if no external force is applied to the door 2.

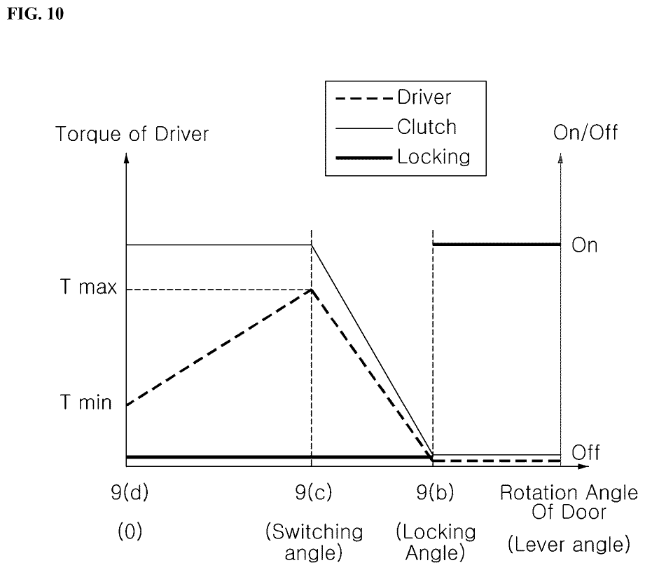

A description of the switching angle and locking angle according to embodiments of the present disclosure will be described later with reference to FIG. 10.

The clutch 44 may be coupled to the other end 434 of the spring 43. The clutch 44 may include a connector 45. The connector 45 may include a second spring coupling portion 453 coupled to the other end 434 of the spring 43.

The connector 450 may include a flange 456. The second spring coupling portion 453 may protrude upward from the flange 456.

The flange 456 may be formed in a circular shape. The flange 456 may have a width greater than that of the second spring coupling portion 453. The flange 456 may support the lower portion of the spring 43.

The connector 45 may include a latch holder 457. The latch holder 457 may protrude downward from the flange 456.

The shaft 46 may include a clutch shaft 463. The latch holder 457 may surround the clutch shaft 463. The clutch shaft 463 may be accommodated within the latch holder 457. The clutch shaft 463 may be inserted into the latch holder 457.

The latch holder 457 may include a first latch receiving portion 4571. The latch holder 457 is formed in a hollow cylindrical shape, and the first latch receiving portion 4571 is formed in a shape penetrating between the inner and outer surfaces of the cylindrical shape and may extend in the longitudinal direction.

The clutch 44 may include a latch 47. The latch 47 may be disposed in the first latch receiving portion 4571. The latch 47 may have a cylindrical shape. The diameter of the latch 47 may correspond to the width of the first latch receiving portion 4571.

A plurality of latches 47 may be provided. For example, there may be two latches 47.

The latch holder 457 may be formed in an arc shape. The first latch receiving portion 4571 may be provided at an end of the arc shape.

The latch holder 457 may be formed in a plurality of arc shapes. The first latch receiving portion 4571 may be positioned between these arc shapes.

A first latch mounting groove 4637 may be formed in the clutch shaft 463. The first latch mounting groove 4637 may be recessed inward from the outer peripheral surface of the clutch shaft 463. The width of the first latch mounting groove 4637 may be less than the diameter of the latch 47. According to the rotation of the lever 5 and/or the clutch shaft 463, the latch 47 may be engaged with or disengaged from the first latch mounting groove 4637.

When the latch 47 is removed from the first latch mounting groove 4637, the connection between the connector 45 and the shaft 46 may be released. Accordingly, the connection between the spring 43 and the shaft 46 may be released.

The clutch 44 may include a clutch housing 49. The clutch housing 49 may include a shaft receiving portion 496. The shaft receiving portion 496 may be provided within the clutch housing 49. The shaft receiving portion 496 may be formed as a hollow portion of the clutch housing 49.

The clutch shaft 463 may be disposed in the shaft receiving portion 496. The inner diameter of the shaft housing 496 may be greater than the outer diameter of the clutch shaft 463.

The latch holder 457 may be disposed between the clutch shaft 463 and the clutch housing 49.

The inner diameter of the shaft receiving portion 496 may correspond to the outer diameter of the latch holder 457. The inner diameter of the shaft receiving portion 496 may be equal to or slightly greater than the outer diameter of the latch holder 457. The latch holder 457 may be rotatably supported in the clutch housing 49.

The clutch housing 49 may include a second latch receiving portion 497. The second latch receiving portion 497 may be recessed outward from the shaft receiving portion 496.

The clutch shaft 463 may rotate according to the rotation of the lever 5. When the clutch shaft 463 rotates according to the rotation of the lever 5, and the first latch mounting groove 4637 and the second latch receiving portion 497 are aligned, the latch 47 may be accommodated in the second latch receiving portion 497.

When the latch 47 is positioned in the groove of the clutch shaft 463 and the second latch receiving portion 497, rotation of the clutch shaft 463 can be restrained with respect to the clutch housing 49 and the housing 41 by the latch 47.

The housing 41 can be fixed to the door 2. Accordingly, rotation of the lever 5 can be restrained with respect to the door 2.

The shaft 46 may include a lever shaft 465. The lever shaft 465 may rotate integrally with the clutch shaft 463. The lever shaft 465 and the clutch shaft 463 may be formed integrally.

A shaft through-hole 499 may be formed at the lower end 498 of the clutch housing 49. The shaft through-hole 499 may communicate with the shaft receiving portion 496.

The lever shaft 465 may pass through the shaft through-hole 499.

The clutch 44 may include a bearing 48. The bearing 48 may rotatably support the shaft 46.

The bearing 48 may be positioned on the upper side of the lower portion of the clutch housing 49. The lever shaft 465 may pass through the bearing 48.

The shaft 44 may include a support ring 464. The support ring 464 may protrude radially from the shaft. The portion of the shaft 44 positioned above the support ring 464 may be referred to as a latch shaft 463, and the portion positioned below the support ring 464 may be referred to as the lever shaft 465. The support ring 464 may be positioned between the latch shaft 463 and the lever shaft 465.

The support ring 464 may support the latch 47 under the latch 47. The support ring 464 may be positioned above the bearing 48 to support the shaft 44.

The lever shaft 465 may be coupled to the lever 5. The lever shaft 465 may rotate integrally with the lever 5.

The lever 5 may include a shaft insertion hole 54 into which the lever shaft 465 is inserted. The outer circumference of the lever shaft 465 may be formed non-circular. The shaft insertion hole 54 may have a shape corresponding to that of the lever shaft 465.

The lever 5 may include a rim 542 disposed around the shaft insertion hole 54. The rim 542 may protrude upward from the body of the lever 5.

A fastening hole 466 may be formed at the end of the lever shaft 465. A fastening hole 56 may also be formed in the lever 5. A fastening member may pass through the fastening hole of the lever 5 and be inserted into the fastening hole 466 of the lever shaft 465 to couple the lever 5 and the lever shaft 465.

The lever 5 may include a rim 562 disposed around the fastening hole 56. The rim 562 may protrude downward from the body of the lever 5.

When the latch 47 is positioned in the groove of the clutch shaft 463 and the second latch receiving portion 497, rotation of the lever 5 with respect to the door 2 may be restrained.

The housing 41 may include a side wall 411. The side wall 411 may be formed in an angular shape, for example, a square pillar shape.

An internal space 413 is formed inside the side wall 411 of the housing 41.

The housing 41 may include a fastening portion 415 protruding from the side wall 411. The fastening portion 415 may be provided at the lower end of the side wall 411. The fastening member 415 may be provided as a pair on both the left and right sides.

The housing 41 may be inserted into the auto-closing receiving portion 234, and the fastening portion 415 may be fastened to the lower surface of the door 2.

The lever shaft 46 may provide a rotation center for the lever 5. The lever 5 can rotate around the shaft insertion hole 54.

The lever 5 may include a finger 51 in which the slit 53 is formed. The finger 51 may extend radially outward from the rotation center of the lever 5.

The finger 51 may include a first finger 511 positioned on one side of the slit 53 and a second finger 512 positioned on the other side. The first finger 511 may be positioned forward of the slit 53, and the second finger 512 may be positioned in the rear of the slit 53.

When an external force is applied to the door 2 in a closing direction while the reference pin 35 is positioned in the slit 53, a force (reaction force) is applied to the first finger 511 by the fixed reference pin 35, and thus the lever 5 can rotate such that the finger 51 moves forward.

When the lever 5 is rotated by the auto-closing device 4 while the reference pin 35 is positioned in the slit 53, the second finger 512 pushes the reference pin 35, and since the reference pin 35 is fixed, the door 2 can rotate or move such that the auto-closing device 4 faces rearward.

Hereinafter, the structure of the lever 5 of the auto-closing device 4 and the operations of the lever 5 and the hinge 3 according to an embodiment of the present disclosure will be described with reference to FIGS. 8 to 10.

Referring to FIG. 8, the door 2 of the refrigerator according to an embodiment of the present disclosure may be rotatably provided at the front of the cabinet 10, and the position of the rotation center of the door 2 may vary depending on the degree of door opening.

The shaft insertion groove 83 of the guide member 80 may have a structure extending with a constant width. For example, the shaft insertion groove 83 may extend in a curved shape. For example, the shaft insertion groove 83 may have an arc shape. For example, the shaft insertion groove 83 may have a shape formed by connecting two arcs having different radii of curvature.

The shaft insertion groove 83 may include a first curved part 831 where the hinge shaft 31 is positioned when the door 2 is closed, and a second curved part 832 where the hinge shaft 31 is positioned when the door 2 is open. The second curved part 832 may be positioned relatively close to the outer end of the door 2, and the first curved part 831 may be positioned relatively far from the outer end of the door 2.

The first and second curved parts 831 and 832 may be connected. The first curved part 831 may extend rearward toward the second curved part 832, and the second curved part 832 may extend rearward toward the first curved part 831. The shaft insertion groove 83 may have a shape that is convex rearward.

The radius of curvature of the second curved part 832 may be smaller than the radius of curvature of the first curved part 831.

The shaft insertion groove 83 movably supports the hinge shaft 31. The door can be opened and closed as the hinge shaft 31 rotates and/or moves within the guide member.

The width of the shaft insertion groove 83 may correspond to the outer diameter of the hinge shaft 31. That is, the width of the shaft insertion groove 83 may be equal to or slightly greater than the outer diameter of the hinge shaft 31 such that the hinge shaft 31 can slide along the shaft insertion groove 83.

Two or more hinge shafts 31 may be provided. For example, the hinge 3 may include two hinge shafts 311 and 312. Hereinafter, among the two hinge shafts 311 and 312, the hinge shaft 311 located relatively inside in the width direction of the door 2 is referred to as a first hinge shaft 311, and the hinge shaft 312 located outside is referred to as a second hinge shaft 312. That is, the first hinge shaft 311 may be disposed relatively close to the front end of the first curved part 831 when the door 2 is closed, and the second hinge shaft 312 may be disposed relatively close to the front end of the second curved part 832 when the door 2 is open.

The door 2 may be provided with a rotation center by the first and second hinge shafts 311 and 312. Here, the position of the rotation center of the door 2 may change depending on the degree of door opening. That is, when the door 2 is opened, the two hinge shafts 31 slide along the shaft insertion groove 83 within the shaft insertion groove 83, and thus the door 2 can rotate.

When the position of the rotation axis of the door 2 is fixed, the front outer edge 203 of the door 2 may deviate from the position of the outer end 204 in the width direction of the door 2 when the door 2 is closed as the door is opened.

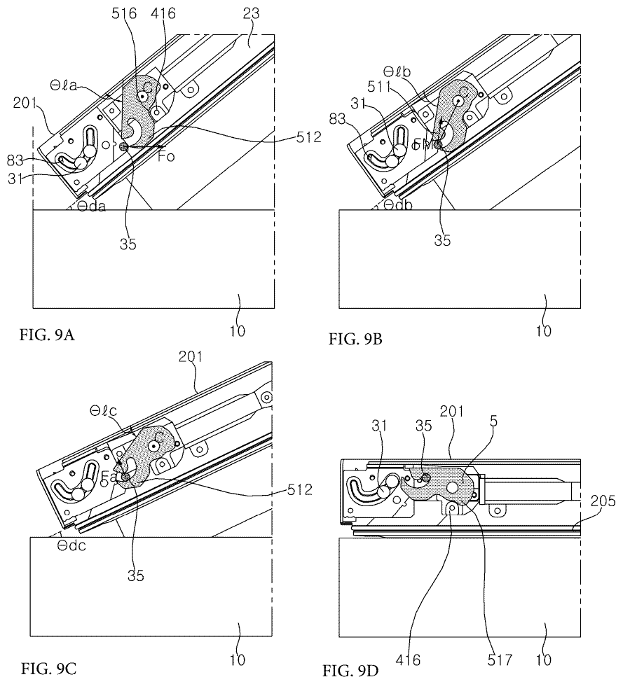

The hinge shaft 31 and shaft insertion groove 83 of the present embodiment ensure that the front outer edge of the door 2 does not deviate from the position of the outer end of the door 2 when the door 2 is closed even when the door 2 is opened, or minimize the extent of such deviation (refer to FIGS. 9A to 9D).

Therefore, in situations where other furniture is placed next to the refrigerator, or the refrigerator is placed in a storage unit and the refrigerator door does not protrude forward relative to the other furniture or storage unit, the door can be opened without interfering with the other furniture or storage unit.

FIGS. 9A to 9D illustrate a state in which the opening angle of the door 2 gradually decreases in the order of (A), (B), (C), and (D).

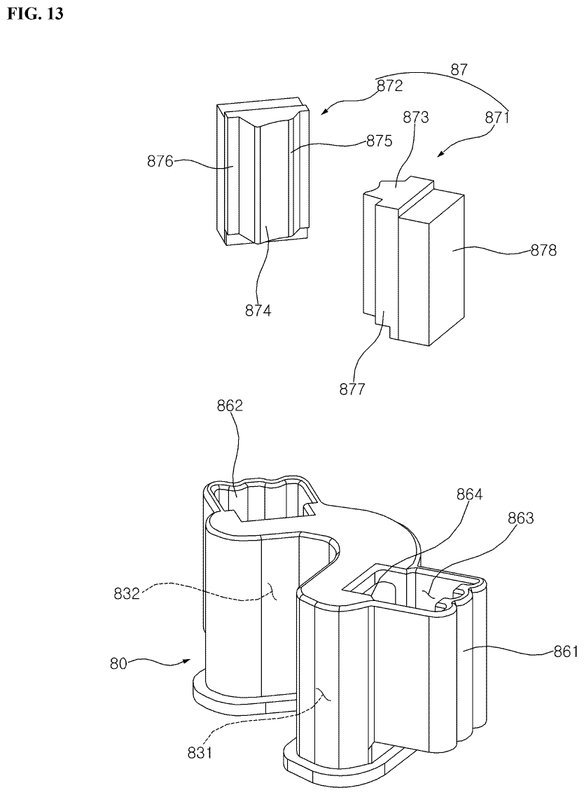

The door 2 can be opened further than in FIG. 9A. For example, the door opening angle θ13a in FIG. 13(a) is 90 degrees, and the maximum opening angle of the door 2 may be greater than 90 degrees. When the door 2 is opened to the maximum, the second hinge shaft 312 may be in contact with the front end of the second curved part 832 or may be slightly separated therefrom. When the door 2 is fully opened, the first and second hinge shafts 311 and 312 can be positioned in the second curved part 832.

For example, when the door 2 is opened 90 degrees, the first hinge shaft 311 can be located at the boundary between the second curved part 832 and the first curved part 831. Therefore, when the door 2 is opened more than 90 degrees, the first and second hinge shafts 311 and 312 can slide along the second curved part 832 (the first and second hinge shafts 311 and 312 are fixed and the guide member 80 moves). Therefore, the door 2 can be opened by coming forward. Therefore, when the door 2 is opened to the maximum, interference with other furniture or appliances placed on the side of the refrigerator 1 can be minimized.

FIG. 9A illustrates a state in which the first hinge shaft 311 is positioned at the first curved part 831 and the second hinge shaft 312 is positioned at the second curved part 832.

In the process of opening the door 2 in the state of FIG. 9A, the second hinge shaft 312 moves relatively along the second curved part 832, and thus the widthwise outer side 204 and the front edge 203 of the door 2 move inwardly in the width direction of the cabinet 10 as the door 2 opens, compared to when the rotation center is fixed. Accordingly, the widthwise outer side 204 and the front edge 203 of the door 2 do not deviate from the outer edge 204 of the door when the door is closed, or if they do, they deviate to a minimum.

FIG. 9B shows a state in which the second hinge shaft 312 is positioned at the boundary between the first curved part 831 and the second curved part 832, and the first hinge shaft 311 is positioned at the first curved part 831, and FIG. 9D shows a state in which the door 2 is closed. When the door 2 is closed, the first hinge shaft 311 may be positioned at the front end of the first curved part 831.

When the door 2 is opened while passing through the state of FIG. 9C to reach the state of FIG. 9B, the first and second hinge shafts 311 and 312 move relatively rearward along the first curved part 831, and thus the outer surface 204 of the door 2 can move inwardly in the width direction as a whole while rotating such that the front end 203 faces rearward. Accordingly, even in this process, the widthwise outer side 204 and the front edge 203 of the door 2 do not deviate from the outer edge of the door when the door is closed, or if they do, they can deviate the outer edge to a minimum.

Referring to FIG. 8, the lever 5 of the refrigerator according to an embodiment of the present disclosure may be rotatably provided on the bottom surface of the door 2. The lever 5 may include the slit 53 into which the reference pin 35 is inserted. The slit 53 may extend in a straight line or have a bent shape. For example, the slit 53 may have a curved shape.

The lever 5 may include the finger 51 extending radially outward from the rotation center. The slit 53 may be formed in the finger 51.

The finger 51 may include first and second fingers 511 and 512. The slit 53 may be formed between the first and second fingers 511 and 512. The first finger 511 may be positioned forward of the slit 53, and the second finger 512 may be positioned rearward of the slit 532.

The slit 53 may include the first region 531 extending outward from the inner end of the slit 53 and the second region 532 extending outward from the first region 531.

The first region 531 is located at the inner end of the slit 53 and may extend rearward and outward. The second region 532 may extend from the first region 531 and may be formed to face forward and outward.

The first region 531 may extend in a curved shape. The first region 531 may have an arc shape. The center of curvature of the first region 531 may be located in the front of the slit 53.

The slit 53 may include a portion extending in the front-back direction. In addition, the slit 53 may not include a portion extending in the tangential direction with respect to the rotational direction of the lever 5. For example, the angle θ531 between the extension direction of the inner end of the first region 531 and the radial direction of the lever 5 may be an obtuse angle. That is, the angle between the center line of the first region 531 and the line connecting the center of the reference pin 35 and the rotation center C of the lever 5 when the door 2 is closed may be greater than 90 degrees. The angle may be less than 180 degrees.

If the slit 53 includes a portion extending forward-backward direction, there is a risk that the clutch will not operate properly when the rotational position of the lever 65 due to the rotation of the door 2 deviates from designed criteria.

For example, if the first region 531 includes a portion extending rearward from the inner end, when the door 2 is opened from a closed state, the reference pin 35 may slide along the first region 531, but the reference pin 35 may not press the lever 65. Accordingly, the door 2 is opened, the reference pin 35 slides along the slit 53, but the lever 5 may not rotate. In other words, when the reference pin 35 passes through the first region 531, there is a risk that the rotational position of the lever 5 due to the rotation of the door 2 deviates from the designed criteria.

Therefore, the slit 53 of the present disclosure may not include a portion extending in the forward-rearward direction.

If the first region 531 includes a portion extending in the tangential direction with respect to the rotational direction of the lever 5, when the reference pin 35 slides along the portion extending in the tangential direction, no force may be applied between the reference pin 35 and the lever 5. That is, the reference pin 35 may slide along the slit 53, but the lever 5 may not rotate. Even in this case, there is a risk that the rotational position of the lever 5 due to the rotation of the door 2 may deviate from the design criteria.

Therefore, the slit 53 of the present disclosure may not include a portion extending in the tangential direction with respect to the rotational direction of the lever 5.

Therefore, the rotational position of the lever 65 according to the rotation of the door 2 can be prevented from deviating from the design standard.

The second region 532 may extend in a curved shape. The second region 532 may have an arc shape. The center of curvature of the second region 532 may be located in the front of the slit 53.

The radius of curvature of the first region 531 may be greater than the radius of curvature of the second region 532.

The torque T of the auto-closing device 4, i.e., the torque T of the spring 53, may be proportional to the angle of rotation from the free state. The auto-closing device 4 rotates the lever 5, and the force exerted by the lever 5 on the reference pin 35 is equal to a value obtained by dividing the torque by the distance between the reference pin 35 and the rotation center of the lever.

The force exerted by the lever 5 on the reference pin 35 may be perpendicular to the surface where the reference pin 35 contacts the lever 5. That is, the force exerted by the lever 5 on the reference pin 35 may be directed toward the center of curvature of the slit 53. Among the forces exerted by the lever 5 on the reference pin 35, the component of the force parallel to the forward-backward direction of the door, which is the rotational radius of the lever 5, may serve as the force that closes the door 2 via the auto-closing device 4.

Meanwhile, at the point where the first region 531 and the second region 532 meet, the slit 53 may extend parallel to the longitudinal direction of the lever 5. That is, as shown in FIG. 7, the tangential direction at the point where the first and second regions 531 and 532 meet, relative to the position of the lever 5 in the closed door state, may be the left-right direction. If the inner end of the slit 53 extends parallel to the tangential direction of the rotational radius of the reference pin 35 and the forward-backward direction of the door, the torque of the auto-closing device 4 cannot be transmitted to the reference pin 35 when the reference pin 35 is positioned at that location.

Therefore, the more gently the slit 53 is bent, the more advantageous it is for the torque T of the auto-closing device 4 to be converted into force for closing the door 2.

As the reference pin 35 moves from the outer end to the inner end of the slit 53, the rotation angle of the lever 5 and the torque of the auto-closing device 4 gradually decrease. By designing the radius of curvature of the first region 531 to be greater than the radius of curvature of the second region 532, even if the torque is reduced, sufficient force can be provided to close the door 2 with the torque of the auto-closing device 4.

The slit 53 may include a third region 533. The third region 533 may extend from the second region 532 and be located at the outermost end of the slit 53.

The third region 533 may extend straight. The third region 533 may extend parallel to the outer end of the second region 532. The first finger 511 may include a straight portion 5113 forming the third region 533. Since the slit 53 includes the straight third region 533, the reference pin 31 may move smoothly along the slit 53 when the reference pin 31 enters the slit 53 during the closing process of the door 2.

If the outer end of the slit 53 is positioned in front of the first finger 511, when the reference pin 35 enters the slit 53 during the closing process of the door 2, the reference pin 35 may press the lever 5 backward. That is, the problem of the lever 5 rotating in the opposite direction may occur.

In addition, the larger the rotation angle of the lever 5 for releasing the restraint of the shaft 46 by the clutch 44, the less force may be required to release the restraint. Therefore, if the length of the slit 53 for releasing the restraint of the clutch 44 is formed short to prevent opposite rotation of the lever 5 described above, a relatively large force may be required to release the restraint of the clutch 44 during the closing process of the door 2.

The lever 5 of the present embodiment includes the third region 533 extending straight from the second region 532, thereby ensuring sufficient lengths of the second and third regions 532 and 533 for the process of releasing the clutch 44, while preventing the lever 5 from rotating in the opposite direction.

Meanwhile, the first region 531 may extend in a curved manner, with the outer end thereof which meets the second region 531 positioned rearward and the inner end thereof positioned forward. Accordingly, the slopes of the second region 532 and the first region 531 may be connected in a continuous or nearly continuous manner.

On the other hand, if the second region 532 does not have a curved portion and the straight portion of the third region 531 meets the first region 531, the sliding direction of the reference pin 35 may sharply change when the reference pin 53 enters the first region 531. In this case, the reference pin 35 may get caught in the slit 53 during the closing process of the door 2, generating noise.

In the lever 5 of the present embodiment, the second region 532 and the first region 531 of the slit 53 extend in a curved manner, and the slopes thereof are continuously connected, allowing the reference pin 35 to move smoothly along the slit 53.

The outer end 5123 of the second finger 532 may be curved. The outer end 5123 of the second finger 532 may have an arc shape. When the door 2 is opened, the reference pin 35 may move away from the outer end 5123 of the second finger 532 and rotate the lever 5, thereby inducing the latch 47 to be mounted on a second latch mounting portion 4638.

The lever 5 may be disposed between the front surface 201 and the rear surface 202 of the door 2. When the door 2 is closed, the front end of the lever 5 may extend parallel to the front surface of the door 2. The front end of the lever 5 may be positioned rearward relative to the front surface of the door 2.

The outer rear end of the lever 5 may extend in a direction intersecting the width direction of the door 2 such that the angle θ formed with respect to the width direction of the door 2 may be less than 90 degrees.

The angle θ may be the maximum rotation angle of the lever 5. That is, when the door 2 is opened to the maximum extent and the lever 61 is rotationally constrained (refer to (a) of FIG. 8), the outer rear end of the lever 5 may be disposed parallel to the rear surface 202 of the door 2. At this time, the outer rear end 6122 of the lever 61 may be positioned forward of the rear surface of the door 2 or forward of the gasket 205 provided on the door 2.

A lever stopper 416 may be provided on the lower surface of the door 2. The lever stopper 416 may protrude downward from the lower surface of the door 2. The lever stopper 416 may be located behind the lever 5.

The lever stopper 416 may be a component of the auto-closing device 4.

Alternatively, the lever stopper 416 may be a component of the cap deco 23 or may be mounted on the cap deco 23.

The lever stopper 416 may protrude from the lower surface of the door 2 and be positioned at the same height as the lever 5.

When the door 2 is opened, the lever 5 rotates with the finger 51 facing rearward and may contact the lever stopper 416. The lever 5 may include a first contact portion 516 that contacts the lever stopper 416 when the door 2 is opened.

The distance between the first contact portion 516 and the rotation center C of the lever 5 may be greater than the distance d between the rotation center C and the lever stopper 416. The first contact portion 516 may include a portion where the distance to the rotation center C of the lever 5 is greater than the distance d between the rotation center C and the lever stopper 416.

Therefore, the first contact portion 516 may contact the lever stopper 416 when the door 2 is opened, and the rotation of the lever 5 can be restricted.

When the door 2 is closed, the lever 5 may rotate in a direction in which the finger 51 faces forward and contact the lever stopper 416. The lever 5 may include a second contact portion 517 that contacts the lever stopper 416 when the door 2 is closed.

The distance between the second contact portion 517 and the rotation center C of the lever 5 may be greater than the distance d between the rotation center C of the lever 5 and the lever stopper 416. The second contact portion 517 may include a portion where the distance to the rotation center C of the lever 5 is greater than the distance d between the rotation center C and the lever stopper 416.

Accordingly, the second contact portion 517 may contact the lever stopper 416 when the door 2 is closed, and the rotation of the lever 5 can be restricted.

The reference pin 35 is fixed to the cabinet 10, and the lever 5 may be provided in the door 2. The reference pin 35 is inserted into the slit 53 of the lever 5 and may slide along the slit 53. When the door 2 rotates with the reference pin 35 inserted into the slit 53, the lever 5 may rotate in accordance with the rotation of the door 2.

When the door 2 rotates in the opening direction, the reference pin 35 is fixed to the cabinet 10 and is positioned between the hinge shaft 31 and the rotation center C of the lever 5, allowing the lever 5 to rotate.

When the door 2 is closed, if the reference pin 35 is inserted into the slit 53, the lever 5 rotates by the torque T of the driver 40 and can apply force to the door 2 in the closing direction.

The lever 5 can rotate in the same direction as the door 2. For example, as shown in FIG. 8, if the door 2 rotates counterclockwise when it is opened and clockwise when it is closed, the lever 5 can also rotate counterclockwise when the door is opened and clockwise when the door is closed.

The rotation angles θ1a, θ1b, and θ1c of the lever 5 may be greater than the rotation angles θda, θdb, and θdc of the door 2. For example, the locking angle θ1b of the present embodiment may be in the range of 45 to 50 degrees, and in this case, the angle θdb between the door 2 and the cabinet 10 may be in the range of 30 to 40 degrees. For example, the switching angle θ1c may be in the range of 28 to 40 degrees, and in this case, the angle θdc) between the door 2 and the cabinet 10 may be in the range of 20 to 30 degrees. For example, when the reference pin 35 contacts the lever 5, the angle θ1a of the lever may be equal to the aforementioned locking angle θ1b, and the angle θda of the may be in the range of 35 to 45 degrees.

The auto-closing device 4 may provide torque T that rotates the lever 5. The auto-closing device 4 may rotate the lever 5 to close the door 2 by the operations of the lever 5 and the reference pin 35.

For example, the reference pin 35 may be disposed between the hinge shaft 31 and the rotation center C of the lever 5 in the width direction of the door 2. When the reference pin 35 is positioned in the slit 53, the reference pin 35 may be disposed between the hinge shaft 31 and the rotation center C of the lever 5 in the width direction of the door 2.

FIG. 9A shows a state in which the reference pin 35 contacts the lever 5. When the clutch 44 is not in a designated position, the lever 5 and the outer end 5123 of the second finger contact each other, and the clutch 44 can be guided to the designated position. The “designated position” may refer to a case in which the rotation angle of the lever 5 is the aforementioned locking angle.

When the door 2 is open or the reference pin 35 is further rotated by the outer end 5213 of the second finger 512 and thus the clutch 44 is aligned at the designated position, the clutch 44 can restrain rotation of the shaft 46 to prevent the lever 5 from automatically rotating relative to the door 2.

For example, if the door 2 is open and the clutch 44 is less rotated than the designated position, when the door 2 closes and the reference pin 35 enters the slit 53, the outer end of the curved second finger 412 contacts the reference pin 35, allowing the lever to rotate further, thereby placing the clutch at the designated position.

For example, when the door 2 is closed, if the reference pin 35 is removed from the slit 53, and the clutch 44 is rotated less than the designated position, the reference pin 35 contacts the outer end 5123 of the second finger as the door 2 opens, allowing the lever 5 to rotate further, thereby allowing the clutch 44 to be positioned at the designated position.

In the process in which the clutch 44 is positioned at the designated position, the first contact portion 516 comes into contact with the stopper 416, preventing the lever 5 and the clutch 44 from rotating further than the designated position.

FIG. 9B illustrates a state in which the rotation angle θ1b of the lever 5 is the locking angle. In this case, the reference pin 35 may be positioned in the third region 533 of the slit 53. During the closing process of the door 2, the reference pin 35 can slide along the third area 533. During this process, the clutch 44 can release the restraint of the shaft 46.

When the door 2 is closed, a force Fm may be applied between the reference pin 35 and the lever 5. When the reference pin 35 is positioned in the third region 533, the reference pin 35 contacts the first finger 511. As the door 2 is closed, the reference pin 35 may press the first finger 511 such that the first finger 511 rotates forward. As the lever 5 rotates, the restraint of the shaft 46 by the clutch 44 can be released.

When an external force is applied to the door 2 in the closing direction, the lever 5 rotates relative to the door 2 such that the finger 51 faces forward due to the reaction force Fm acting from the reference pin 35 to the first finger 511.

Meanwhile, the lever 5 is mounted on the door 2, and the rotation center C of the lever 5 is at a fixed position on the door 2, and thus the distance between the reference pin 35 and the rotation center C of the lever 5 changes when the door 2 rotates. Therefore, when the door 2 rotates, the reference pin 35 slides in the slit 53. Here, sliding of the reference pin 35 means that the reference pin 35 is fixed and the slit 53 moves.

The third region 533 may face rearward and inward. Therefore, even if the door 2 rotates slightly during the release of the restraint of the clutch 44, the lever 44 may rotate significantly. Therefore, the restraint of the clutch 44 can be released rapidly.

FIG. 9C illustrates a state in which the rotation angle θ1c of the lever 5 is the switching angle. That is, as the door 2 is closed, the clutch 44 gradually connects the shaft 46 and the spring 43. In the state shown in FIG. 9C, the clutch 44 can connect the shaft 46 and the spring 43. At this time, the reference pin 35 may be located at the boundary between the second region 532 and the first region 531.

Since the clutch 44 connects the spring 43 and the shaft 44 in the state shown in FIG. 9C, the driver 40 can rotate the lever 5 to close the door 2.

The spring 43 of the auto-closing device 4 provides torque to the lever 5 in a direction in which the finger 51 faces forward.

When the lever 5 rotates such that the finger 51 faces forward (clockwise in FIG. 8), the lever 5 applies a forward force Fa to the reference pin 35. The position of the reference pin 35 is fixed, and the door 2 can rotate around the hinge shaft 31 or a rotation center closer to the edge of the door 2 than the hinge shaft 31. Therefore, the rotation center C of the lever 5 can move in the direction in which the lever 5 rotates relative to the reference pin 35. In other words, the rotation center C of the lever 5 can move rearward. The door 2 can rotate such that the rotation center C of the lever 5 faces rearward.

Accordingly, the door 2 can be closed by the force of the driver 40 rotating the lever 40.

When the lever 5 rotates and the door 2 is closed, the reference pin 35 can slide relatively along the first region 532.

When the door 2 is closed, the second finger 52 presses the reference pin 35 forward. The second region 532 may be formed to be curved. Therefore, when the lever 5 rotates and applies force to the reference pin 35, the reference pin 35 can slide smoothly.

As shown in FIG. 9D, when the door 2 is closed, the reference pin 35 can contact the inner end of the slit 53. As shown in FIG. 9D, when the door 2 is closed, the second contact portion 517 can contact the stopper.

The door 2 can be opened in the order of (D), (C), (B), and (A) of FIG. 9 (excluding the force and direction indicated by the arrows). When the door 2 is opened, the rotation center c of the lever 5 moves forward, and since the reference pin 35 is fixed, the lever 5 rotates such that the finger 51 faces rearward.

If the door 2 is further opened beyond the state (A) of FIG. 9, the first contact portion 616 may contact the lever stopper 416, preventing the lever 61 from rotating further. The reference pin 35 may be removed from the slit 613. Furthermore, the lever 5 may be restrained by the clutch 44.

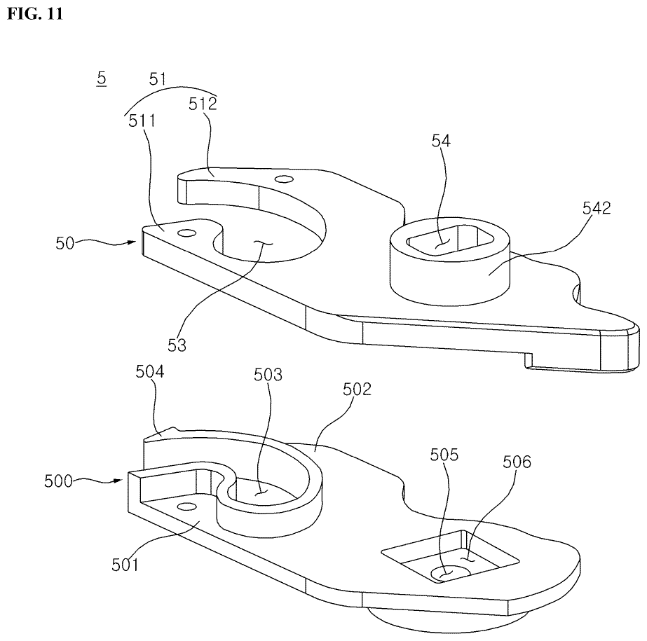

Referring to FIG. 11, the lever 5 according to an embodiment of the present disclosure may include a lever body 50. The lever body 50 may include the finger 51 and the slit 53 described above.

The shaft insertion hole 54 described above may be formed in the lever body 50. A rim 542 may protrude from the lever body 50. The rim 542 may protrude upward from the lever body 50. The shaft insertion hole 54 may have a shape that penetrates the lever body 50 and the rim 542.

The lever 5 may include a lever cap 500. The lever cap 500 may be coupled to the lever body 50. The lever cap 500 may have a shape corresponding to the lever body 50.

The lever cap 500 may include a first finger cap 501 coupled to the first finger 511 and a second finger cap 502 coupled to the second finger 512.

A slit cover 504 may protrude upward along the inner edges of the first and second finger caps 501 and 502. The slit cover 504 may be inserted into the slit 53 of the lever body 50. A slit 503 may be formed on the inner side of the slit cover 504, and the reference pin 35 may be inserted into the slit 503.

The lever cover 500 may include a rim receiving portion 506. The rim 562 protruding downward from the lever body 50 may be inserted into the rim receiving portion 506.

The lever cover 500 may include a fastening hole 505. The fastening hole 505 may be formed in the rim receiving portion 506.

The fastening hole 505 may penetrate the lever cover 500 vertically. A fastening member may penetrate the fastening holes 505 and 56 of the lever cover 500 and the lever body 50 and be inserted into the fastening hole 466 of the shaft 46, thereby coupling the lever 5 and the shaft 46.

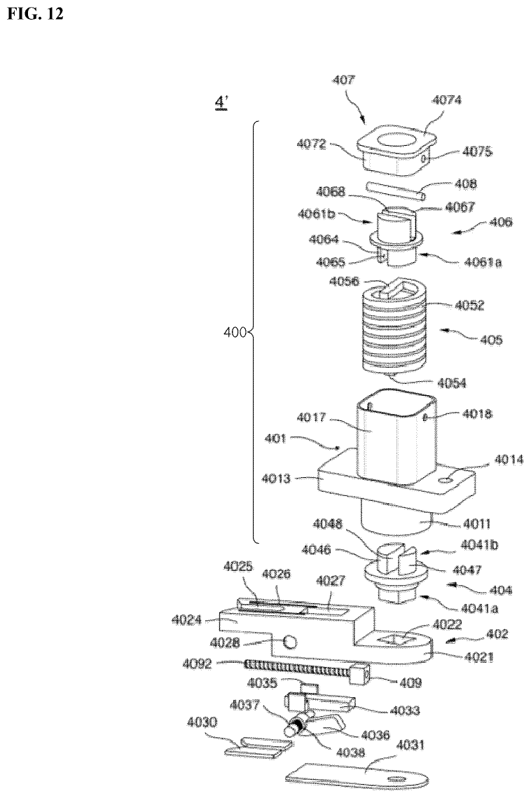

Hereinafter, an auto-closing device 4′ and a lever 402 according to another embodiment of the present disclosure will be described with reference to FIG. 12.

Referring to FIG. 12, the auto-closing device 4′ of the present embodiment may include a driver 400 and the lever 402. The driver 400 may include a housing 401 and a spring 405. The housing 401 may form the outer shape of the driver 400.

The lever 402 may be rotatably coupled to the driver 400. The lever 402 may rotate horizontally with respect to a rotational center line extending vertically.

The spring 405 may be, for example, a torsion spring. The spring 405 may include a spiral portion 4052 formed by winding a wire multiple times.

The spring 405 may include one end 4056 extending from the upper end of the spiral portion and the other end 4054 extending from the lower end of the spiral portion 4052. The one end 4056 and the other end 4054 may extend inwardly along the radius of the spiral portion.

The driver 400 may further include a first connector 404 connected to the lever 402. The first connector 404 may be disposed within the housing 401 and may have a portion protruding outward from the housing 401 to be connected to the lever 402.

The first connector 404 may be connected to the lever 402. The first connector 404 may rotate along with the lever 402.

The first connector 404 may connect the spring 405 and the lever 402. The first connector 404 may include a lever coupling portion 4041a and a first spring coupling portion 4041b.

The other end 4054 of the spring 405 may be coupled to the first connector 404. For example, the other end 4054 of the spring 405 may be inserted into a coupling space 4048 of the first spring coupling portion 4041b.

When the other end 4054 is accommodated in the coupling space 4048, the first spring coupling portion 4041b may be accommodated within the spiral portion 4052. That is, the spiral portion 4052 may surround the first spring coupling portion 4041b and be coupled to the first spring coupling portion 4041b.

The spring coupling portion 4041b may include a first rib 4046 and a second rib 4047 that are spaced apart from each other in the horizontal direction. The coupling space 4048 may be formed between the first rib 4046 and the second rib 4047. The other end 4054 of the spring 405 may be accommodated in the coupling space 4048.

The lever coupling portion 4041a may be formed with a non-circular horizontal cross-section to prevent the lever coupling portion 4041a from spinning while coupled with the lever 402. For example, the lever coupling portion 4041a may be formed with a polygonal horizontal cross-section.

The driver 400 may further include a second connector 406 coupled with the spring 405. One end 4056 of the spring 405 may be coupled with the second connector 406. The second connector 406 may be formed in a similar shape to the first connector 405.

The second connector 406 may include a second spring coupling portion 4061a and a pin coupling portion 4061b. The second connector 406 may further include a partition plate 4062 positioned between the second spring coupling portion 4061a and the pin coupling portion 4061b.

The pin coupling portion 4061b may be positioned on the upper side of the partition plate 4062 and the second spring coupling portion 4061a may be positioned on the lower side.

The second spring coupling portion 4061a may include a first rib 4063 and a second rib 4064 that are spaced apart from each other in the horizontal direction. A first coupling space 4065 may be formed between the first rib 4063 and the second rib 4064.

The one end 4056 of the spring 405 may be inserted into the first coupling space 4065. When the one end 4056 is accommodated in the first coupling space 4065, the second spring coupling portion 4061a may be accommodated inside the spiral portion 4052. That is, the spiral portion 4052 can surround the second spring coupling portion 4061a and be coupled with the second spring coupling portion 4061a.

The pin coupling portion 4061b may include a third rib 4066 and a fourth rib 4067 that are spaced apart from each other in the horizontal direction. A second coupling space 4068 may be formed between the third rib 4066 and the fourth rib 4067.

The driver 400 may further include an upper cap 4074 covering an upper opening of the housing 401.

The upper cap 4074 may include a cap body 4072 having a hollow space 4073 formed therein, and a flange 4074 extending horizontally from the upper end of the cap body 4072.

The cap body 4072 may be inserted into the interior of the housing 401, and the flange 4074 may be mounted on the upper surface of the housing 401. The pin coupling 4061b may be inserted into the hollow space 4073.

The driver 400 may further include a fixing pin 408 for fixing the upper cap 4074 to the housing 401.

A pair of first pin holes 4018 through which the fixing pin 408 passes may be formed in the housing 401. The cap body 4072 may include a pair of second pin holes 4075 through which the fixing pin 408 passes.

The fixing pin 408 may be inserted into the second coupling space 4068. That is, the fixing pin 408 may pass through one first pin hole 4018 and one second pin hole 4075, then pass through the second coupling space 4068, and then pass through another second pin hole 4075 and another first pin hole 4018.

The upper cap 407 and the second connector 406 are fixed in position while connected to the housing 401 by the fixing pin 408. That is, rotation of the upper cap 407 and the second connector 406 is restricted by the fixed pin 408.

That is, in the present embodiment, one end 4056 of the spring 405 is a fixed end, and the other end 4054 is a movable end. Therefore, while the one end 4056 is fixed, the other end 4054 can rotate along with the lever 402.

When the other end 4054 of the spring 405 rotates in one direction while the one end 4056 of the spring 405 is fixed, the spring 405 accumulates elastic force. The elastic force accumulated in the spring 405 can act on the lever 402 such that the lever 402 rotates in the other direction opposite to the one direction.

The elastic force accumulated by the spring 405 in this manner acts on the door 2 during the closing process of the door 2, thereby automatically closing the door 2 at a predetermined position.

The structure for fixing the one end 4056 of the spring 405 described above is exemplary, and various fixing structures may be applied. For example, the one end 4056 of the spring 405 is directly fixed to the housing 401 or the upper cap 407.

The housing 401 may include a first body 4011 that accommodates the first connector 404 and a second body 4017 that accommodates the spring 405.

The second body 4017 may be provided on the upper side of the first body 4011. The space within the second body 4017 where the spring 405 is disposed and the space within the first body 4011 where the first connector 404 is disposed may be connected to each other.

The housing 401 may include a laterally protruding coupling portion 4013. The coupling portion 4013 may be coupled to the door 2. A fastening hole 4014 is formed in the coupling portion 4013, and a fastening member may pass through the fastening hole 4014 and be coupled to the door 2, thereby fastening the auto-closing device 40 to the door 2.

The lever 402 may include a coupling slot 4022 coupled to the lever coupling portion 4041a. The coupling slot 4022 may be formed in a shape and size corresponding to the lever coupling portion 4041a.

The lever 402 may include a first portion 4021 that is coupled with the first connector 404. The first portion 4021 may be provided with the coupling slot 4022.

The lever 402 may include the first portion 4021 and a second portion 4024. The second portion 4024 may have an upper surface and two sides, and may have an open lower surface. Furthermore, the lower surface of the first portion 4021 may also be open.

The second portion 4024 may be stepped relative to the first portion 4021. The lower surface of the lever 402 may be stepped. The lower surface of the lever 402 may be covered by a first cover 4030 and a second cover 4031.

The lever 402 may include a slit 4025 through which the reference pin 35 may be accommodated and moved. For example, the slit 4025 may be formed in the central portion of the second portion 4024.

The slit 4025 may extend in the longitudinal direction of the lever 402. For example, the slit 4025 may extend horizontally from the end of the second portion 4024 toward the first portion 4022. The reference pin 35 may be withdrawn from the slit 4025 when the first door 21 is opened by a reference angle or more, and may be inserted into the slit 4025 when the first door 21 is opened by the reference angle or less or closed.

The driver 400 may further include a sliding member 4033 slidably connected to the lever 402. The sliding member 4033 may slide horizontally on the lever 402. That is, the sliding member 4033 may move in a direction intersecting the rotational center line of the lever 402.

For example, the sliding member 4033 may be disposed to be slidable within a space formed by the second portion 4024.

The sliding member 4033 may include a guide rib 4035 for guiding sliding of the sliding member 4033. The second portion 4024 may include a rib slot 4026 in which the guide rib 4035 is accommodated.

An elastic member that provides elastic force to the sliding member 4033 may be provided within the lever 402. The elastic member may be, for example, a coil spring 4092. In addition, a spring holder 409 that supports the coil spring 4092 may be provided within the lever 402.

The sliding member 4033 may include an extension portion 4034 for supporting the coil spring 4092. For example, the sliding member 4033 may be movable in a first direction (longitudinal direction), and the extension portion 4034 may extend from the sliding member 4033 in a direction intersecting the first direction. Accordingly, the coil spring 4092 may be positioned on one side of the sliding member 4033. As another example, a pair of coil springs 4092 may be positioned on both sides of the sliding member 4033 to elastically support the sliding member 4033.

The coil spring 4092 may provide elastic force to the sliding member 4033 in a direction in which a portion of the sliding member 4033 is exposed to the slit 4025.

The direction in which a portion of the sliding member 4033 is exposed to the slit 4025 is a direction in which the sliding member 4033 moves away from the rotation center of the lever 402.

The sliding member 4033 may move in both forward and reverse directions. The direction in which the sliding member 4033 moves away from the rotation center of the lever 402 may be referred to as the forward direction.

If no external force is applied to the sliding member 4033, the sliding member 4033 is positioned in the slit 4025 by the elastic force of the coil spring 4092.

The auto-closing device 4′ may further include a locking member 4036 rotatably provided on the lever 402. For example, the locking member 4036 may be positioned within the lever 402.

The locking member 4036 is coupled to a shaft 4037, and the shaft 4037 may be inserted into a shaft hole 4028 of the second portion 4024 and rotated. The shaft 4037 may extend, for example, in the horizontal direction. That is, the locking member 4036 can rotate around a rotation center line extending in the horizontal direction.

The shaft 4037 may be coupled to the lever 402 at a position lower than the sliding member 4033.

Accordingly, the locking member 4036 can rotate along with the lever 402, and can also rotate relative to the lever 402 with respect to the shaft 4037.

The locking member 4036 may be connected to an elastic member. The elastic member may be, for example, a torsion spring 4038. One end of the torsion spring 4038 may be connected to the locking member 4036, and the other end thereof may be supported by or in contact with the second portion 4024. Other types of springs besides the torsion spring 4038 may also provide elastic force to the locking member 4036.

The lever 402 may have an opening 4027 through which the locking member 4036 passes. For example, the opening 4027 may be formed on the upper surface of the second portion 4024.

The locking member 4036 receives elastic force from the torsion spring 4038 in a direction in which the locking member 4036 rotates upward by penetrating the opening 4027 while installed on the lever 402.

The locking member 4036 may be rotated by the sliding member 4033 when the sliding member 4033 moves in the reverse direction. If no external force is applied to the locking member 4036 (when the sliding member 4033 has moved in the forward direction to a stop position), a portion of the locking member 4036 may be coupled to the housing 401 by penetrating the opening 4027 of the lever 402.

The housing 401 may include a locking groove 4015 that accommodates the locking member 4036 protruding upward from the lever 402. For example, the locking groove 4015 may be provided on the lower surface of the fastening extension portion.

When the locking member 4036 is inserted into the locking groove 4015, the lever 402 cannot rotate with respect to the housing 401. On the other hand, when the locking member 4036 is removed from the locking groove 4015, the lever 402 can rotate with respect to the housing 401.

Therefore, in the present embodiment, the state in which the locking member 4036 is inserted into the locking groove 4015 may be referred to as a locked state of the lever 402. The state in which the locking member 4036 is removed from the locking groove 4015 may be referred to as an unlocked state of the lever 402.

Additionally, in the present embodiment, the direction in which the locking member 4036 rotates to be inserted into the locking groove 4015 may be referred to as a locking direction, and the direction in which the locking member 4036 rotates to be removed from the locking groove 4015 may be referred to as an unlocking direction.

Referring to FIG. 13, the deceleration part 87 may include a first deceleration part 871 and a second deceleration part 872. The first deceleration part 871 and the second deceleration part 872 may have shapes that are symmetrical to each other. The first r deceleration part 871 may be disposed in the first curved part 831, and the second deceleration part 872 may be disposed in the second curved part 832.

The deceleration part 87 may be mounted in the guide member 80. The guide member 80 may include a deceleration housing 861 and 862 that accommodates the deceleration part 87. The deceleration housing 861 and 862 may provide a space 863 that accommodates the deceleration part 87. The space 863 may be open upward.

The deceleration housing may include a first deceleration housing 861 that accommodates the first deceleration part 871 and a second deceleration housing 862 that accommodates the second deceleration part 872. The first deceleration housing 861 may be connected to the first curved part 831, and the second deceleration housing 862 may be connected to the second curved part 832.

The deceleration part 87 may include a protrusion 873 disposed in the shaft insertion groove 83 and an elastic portion 878 made of an elastic material. The elastic portion 878 may be made of an elastic material, such as rubber or synthetic resin.

The deceleration housings 861 and 862 may be provided on the outer surface of the guide member 80. The protrusion 873 may penetrate the outer surface of the guide member 80 including the deceleration housings 861 and 862. A through hole 864 may be formed in the outer surface, and the through hole 864 may connect the shaft insertion groove 83 and the deceleration part accommodation space 863.

The through hole 864 may have a shape corresponding to the protrusion 873. The elastic portion 878 may be positioned in the accommodation space 863, and the protrusion 873 may pass through the through hole 864 and be positioned in the shaft insertion groove 83.

The deceleration part 87 may include a support portion 877. The support portion 877 may be wider than the protrusion 873. The support portion 877 may be positioned in the accommodation space 863 and may be in contact with the outer surface of the guide member 80. Therefore, only the protrusion 873 can be positioned in the shaft insertion groove 83, and the support portion 877 and the elastic portion 878 can be positioned in the accommodation space 863.

The protrusion 873 may include a first inclined surface 874 facing the inside of the shaft insertion groove 83. The first inclined surface 874 is disposed in the shaft insertion groove 83 so as to interfere with the hinge shaft 31 when the door 2 is completely closed during the closing process or completely opened during the opening process. The first inclined surface 874 of the first deceleration part 871 may interfere with the hinge shaft 31 during the closing process of the door 2, and the first inclined surface 874 of the second deceleration part 872 may interfere with the hinge shaft 31 during the opening process of the door 2.

The protrusion 873 may include an extension 875 that connects the support portion 877 and the first inclined surface 874. The extension 875 may extend to correspond to the thickness of the outer surface of the guide member 80.

The protrusion 873 may include a second inclined surface 876 facing the outside of the shaft insertion groove 83. The second inclined surface 876 may be inclined in the opposite direction to the first inclined surface. The second inclined surface 876 may extend between the first inclined surface 874 and the support portion 877.

The second inclined surface 876 may interfere with the hinge shaft 31 when the door 2 is opened from a closed state, and when the door 2 is closed from a fully open state. The second inclined surface 876 of the first deceleration part 871 may interfere with the hinge shaft 31 when the door is opened from a closed state, and the second inclined surface 876 of the second deceleration part 872 may interfere with the hinge shaft 31 when the door 2 is closed from an open state.

The first inclined surface 874 may be inclined more gently than the second inclined surface.

Therefore, deceleration can be smoothly performed when the door 2 is closed or opened.

The first deceleration part 871 and the first deceleration housing 861 may be positioned on the inner side of the door 2 in the width direction, and the second deceleration part 872 and the second deceleration housing 862 may be positioned on the outer side of the door 2 in the width direction. That is, the first deceleration part 871 and the first deceleration housing 861 may be positioned such that the hinge shaft 311 corresponds to the position thereof when the door 2 is closed, and the second deceleration part 872 and the second deceleration housing 862 may be positioned such that the hinge shaft 311 corresponds to the position thereof when the door 2 is open.

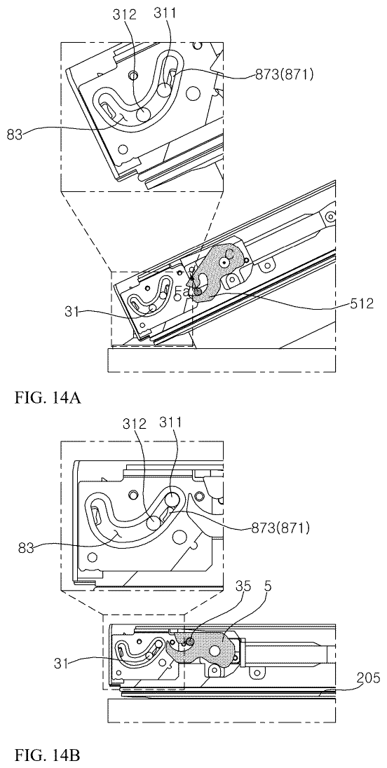

FIGS. 14A and 14B illustrate the process of closing the door 2. Referring to FIG. 14A, the lever 5 rotates by the auto-closing device 4, and the second finger 512 pushes the reference pin 35 forward Fa, closing the door 2.

The hinge shaft 31 may include a first hinge shaft 31a located on the inner side of the door 2 in the width direction and a second hinge shaft 31b located on the outer side.

The protrusion 873 of the first deceleration part 871 may interfere with the first hinge shaft 31a.

When the door 2 is closed and the first hinge shaft 31a moves toward the inner end of the shaft insertion groove 83, the first hinge shaft 31a and the first deceleration part 871 may interfere with each other. The first hinge shaft 31a presses the first inclined surface 874, compressing the elastic portion 878 and allowing the protrusion 873 to be drawn into the accommodation space 863.

During this process, the closing speed of the door 2 can be reduced.

FIG. 14B illustrates a state in which the door 2 is completely closed. Referring to FIG. 14B, when the door 2 is completely closed, the first hinge shaft 31a may be positioned between the inner end of the shaft insertion groove 83 and the first deceleration part 871. The first deceleration part 871 may be positioned between the first and second hinge shafts 31a and 31b. The second hinge shaft 31b may be positioned between the first deceleration part 871 and the second deceleration part 872.

When the door 2 is opened from a closed state, the first hinge shaft 31a presses the second inclined surface 876, the protrusion 873 is drawn into the accommodation space 863 and the first hinge shaft 31a can pass through the second inclined surface 876 and the first inclined surface 874 and slide in the shaft insertion groove 83.

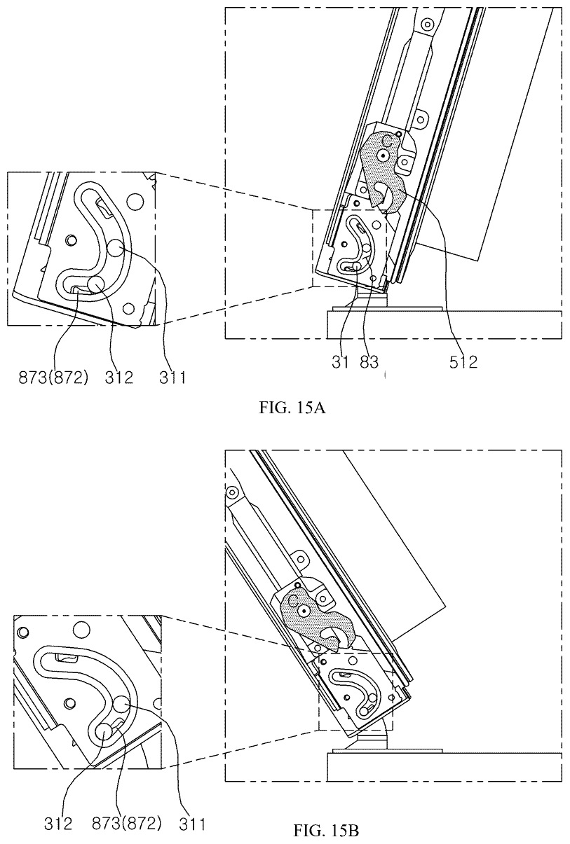

FIGS. 15A and 15B illustrate the process of opening the door 2. Referring to FIG. 15A, the protrusion 873 of the second deceleration part 872 may interfere with the second hinge shaft 31b.

When the door 2 is opened and the second hinge shaft 31b moves toward the outer end of the shaft insertion groove 83, the second hinge shaft 31b and the second deceleration part 872 may interfere with each other. The second hinge shaft 31b presses the first inclined surface 874, compressing the elastic portion 878 and allowing the protrusion 873 to be drawn into the accommodation space 863.

During this process, the opening speed of the door 2 can be reduced.

FIG. 15B illustrates a state in which the door 2 is fully opened. Referring to FIG. 15B, when the door 2 is fully opened, the second hinge shaft 31b may be positioned between the outer end of the shaft insertion groove 83 and the second deceleration part 872. The second deceleration part 872 may be positioned between the first and second hinge shafts 31a and 31b. The first hinge shaft 31a may be positioned between the second deceleration part 872 and the first deceleration part 871.

When the door 2 is rotated in the closing direction from a fully open state, the second hinge shaft 31b presses the second inclined surface 876, the protrusion 873 is drawn into the accommodation space 863, and the second hinge shaft 31b pass through the second inclined surface 876 and the first inclined surface 874 and can slide in the shaft insertion groove 83.

The embodiments or other embodiments of the present disclosure described above are not mutually exclusive or distinct. The embodiments or other embodiments of the present disclosure described above may be combined or incorporated into the configurations or functions thereof.

For example, a configuration A described in a specific embodiment and/or drawing may be combined with a configuration B described in another embodiment and/or drawing. In other words, even if a combination between components is not directly described, this means that combination is possible, except where combination is described as impossible.

The above detailed description should not be construed as limiting in any respect, but rather as illustrative. The scope of the present disclosure should be determined by a reasonable interpretation of the appended claims, and all modifications within the scope of equivalents of the present disclosure are intended to be included within the scope of the present disclosure.

What is claimed is:

1. A home appliance comprising:
a cabinet defining a storage compartment that opens forward;
a door rotatably provided at a front of the cabinet and configured to open and close the storage compartment;
a hinge fixed to the cabinet and configured to rotatably support the door, the hinge including a first hinge shaft;
a guide member provided at the door and including a shaft insertion groove into which the first hinge shaft is inserted; and
a first deceleration part disposed at the guide member and including a first protrusion protruding into the shaft insertion groove,
wherein the shaft insertion groove has a width corresponding to a diameter of the first hinge shaft and extends such that the first hinge shaft is slidable along the shaft insertion groove based on rotation of the door with respect to the cabinet, and the first protrusion is movable in a width direction of the shaft insertion groove.

2. The home appliance of claim 1, wherein the first hinge shaft is positioned between one end of the shaft insertion groove and the first protrusion when the door is closed.

3. The home appliance according to claim 2, further comprising a second deceleration part disposed at the guide member, spaced apart from the first deceleration part, and including a second protrusion protruding into the shaft insertion groove.

4. The home appliance of claim 3, wherein the shaft insertion groove includes:
a first curved part extending rearward toward an outer end of the door in the width direction of the door; and
a second curved part extending from the first curved part toward the outer end of the door and extending forward toward the outer end of the door, and
wherein the first deceleration part is positioned in the first curved part, and the second deceleration part is positioned in the second curved part.

5. The home appliance of claim 4, wherein the hinge further includes a second hinge shaft spaced apart from the first hinge shaft.

6. The home appliance of claim 5, wherein the second hinge shaft is positioned between another end of the shaft insertion groove and the second protrusion when the door is open.

7. The home appliance of claim 2, wherein the first protrusion includes:
a first inclined surface positioned opposite the one end of the shaft insertion groove; and
a second inclined surface located on a side one end of the shaft insertion groove.

8. The home appliance of claim 7, wherein the first inclined surface is inclined less steeply than the second inclined surface.

9. The home appliance of claim 1, wherein the guide member further includes:
a deceleration housing provided on an outer surface of the guide member and accommodating the first deceleration part; and
a through hole penetrating the outer surface of the guide member and connecting an internal space of the deceleration housing with the shaft insertion groove, the first protrusion being inserted into the through hole, and
wherein the first deceleration part further includes an elastic portion disposed in the deceleration housing and pressing the first protrusion toward the shaft insertion groove.
